(19) United States
(12) Patent Application Publication
(10) Pub. No.: US 2017/0291402 A1
(43) Pub. Date: Oct. 12, 2017

(54) METHODS OF RECYCLING WASTE LATEX PAINT

(71) Applicant: IMAFLEX INC., Montreal (CA)

(72) Inventor: Fadi EL CHEIKH ALI, Pierrefonds (CA)

(21) Appl. No.: 15/511,958

(22) PCT Filed: Sep. 24, 2015
(86) PCT No.: PCT/CA2015/050945

§ 371 Date: Mar. 16, 2017

Related U.S. Application Data
(60) Provisional application No. 62/055,285, filed on Sep. 25, 2014.

(51) Int. Cl. B32B 27/32; B32B 27/18; B32B 27/20; C08J 11/06; B32B 27/36; B32B 27/38; B32B 27/40; C08J 5/18; B32B 27/08; B32B 27/30

(52) U.S. Cl. CPC B32B 27/32; B32B 27/08; B32B 27/18; B32B 27/20; B32B 27/306; B32B 27/308; B32B 27/36; B32B 27/38; B32B 27/40; C08J 5/18; C08J 11/06; B32B 2250/24; B32B 2255/26; B32B 2272/00; B32B 2307/402; B32B 2410/00; B32B 2439/06; B32B 2439/46; C08J 2333/00

(57) ABSTRACT

There are provided herein polymeric films and sheet structures comprising treated latex paint and one or more water-insoluble polymer component, methods for producing such films using a continuous film-making process, and articles thereof. Methods provided herein allow recycling of waste latex paint into thin films and sheets using continuous film-making processes and/or while controlling levels of toxic or volatile contaminants.

### RELATED APPLICATIONS

This application claims priority to U.S. provisional application No. 62/055,285 filed on Sep. 25, 2014, the entire contents of which are hereby incorporated by reference.

### TECHNICAL FIELD

The present disclosure relates to the field of polymeric films containing latex paint polymers. More specifically, the present disclosure relates to thin polymeric film structures which contain treated waste latex paint and to processes of making such films.

### BACKGROUND

Leftover latex paint is one of the most highly problematic household chemical wastes produced. It is estimated that about 5-10% of the 30 million liters of latex paint sold in Alberta each year ends up as waste in landfills, which can pose environmental and health risks if disposed of improperly. According to the United States Environmental Protection Agency (EPA), one gallon of improperly disposed paint has the ability to pollute up to 250,000 gallons of water.

Although latex paint compositions vary widely, latex paint generally includes at least four basic components: pigment or colorant to provide color and hiding; latex polymer as binder, for film-forming and adhesion of the paint; water as solvent, making the paint flow-able prior to use; and ethylene glycol or propylene glycol as an anti-freeze agent to keep the emulsion stable in cold weather. Latex paint may also contain fillers like kaolin and calcium carbonate. Typical latex binders for paints are made of acrylic, ethylene, styrene, butadiene, or vinyl acetate ingredients. Styrene-butadiene (SB) polymer was the original vinyl binder used in latex paint and is still predominantly used for interior paints, while polyvinyl acetate (PVA) is used mostly as binder for lower quality, inexpensive latex paints. High-performance latex or water-based paints for both interior and exterior surfaces often contain 100% polyacrylic binders to enable the coating to last and retain its color longer. Polyacrylic binders for common interior house paint are often mixtures of acrylic and vinyl ingredients to balance cost and performance.

Current paint recycling methods cannot keep up with the volumes of waste paint generated by consumers. It is estimated that millions of pounds of waste latex paint are generated annually, and approximately 30 percent of recollected waste latex paint is non-reusable scrap, posing an environmental threat. Although in some cases reusable latex paints of the same color and type can be mixed together, adjusted with colorants and additives, and packaged for reuse, paint reuse is not always possible or cost effective due to the unsuitable quality of the recollected latex paint, resulting from bacterial growth, curing, oxidation, and so on. A small portion of this “non-reusable” paint can be used in the production of concrete as a partial replacement for water and virgin latex polymers as polymer modifier.

Ethylene glycols are members of the class of compounds called alcohols and part of the group of chemicals called diols. Ethylene glycols have properties characteristic of alcohols and undergo reactions typical of alcohols and diols. Due to the toxic nature of ethylene glycol, conventional handling and compounding approaches do not eliminate the adverse environmental impact of ethylene glycol present in waste latex paints. Hence, cost effective treatment methods are needed to ensure containment of this and other undesirable chemicals in waste paint.

U.S. Pat. No. 8,071,685 discloses a method of recycling latex paints as a component of an immiscible polymer blend including a first polymer component including a paint polymer phase and a second polymer component immiscible with the first polymer component and selected from polyolefins and polymethylmethacrylate (PMMA). A method of recycling paint by blending a first polymer component including a paint polymer phase with a second polymer component immiscible with the first polymer component and selected from polyolefins and polymethylmethacrylate (PMMA) is also described. Injection molding of latex paint polymer blends into tensile specimens is demonstrated, and formation of articles with the polymer blends via various molding process techniques, such as injection molding, thermoforming, rotational molding, and extrusion molding, is discussed. However, the methods disclosed in U.S. Pat. No. 8,071,685 cannot be successfully implemented in extrusion processes such as blown film and cast film extrusion to produce thin films or articles thereof; such processes require polymer grades with lower solvent residue content, lower gel agglomeration or gel content, and/or filler of specific particle size compared to polymers used in molding or thermoforming processes. Minerals incorporated in a thin film polymer matrix may require specific particle size distributions and top particle size, and in some cases surface modification is needed to compatibilize the mineral and polymer blend (see Cantor, K., Hanser Gardner Publications 2006; Ruiz, F. A. and Allen, C. F., TAPPI Polymers, Laminations and Coatings Conference Proceedings, 365-373 (1987) and Ruiz, F. A., SPE Antec., 2766-2769 (1994)). Removal or neutralization of toxic and/or volatile components is also required for some applications. The described polymer blends and techniques are therefore not suitable for use in making plastic films or articles such as garbage bags, grocery sacks, shrink films, and industrial liners.

There is a need for practical recycling technology to allow reuse of waste latex paint in polymeric thin films or sheets and articles thereof.

### SUMMARY

It is an object of the present technology to ameliorate at least some of the inconveniences present in the prior art, particularly related to recycling of waste latex paint in polymeric film and sheet articles. Accordingly, there are provided herein methods and systems for recycling latex paint in a polymeric film or sheet structure, and articles made thereof. In some embodiments, methods are provided for recycling latex paint that allow production of polymeric films using a continuous film-making process such as blown film extrusion or cast film extrusion, and/or that control levels of toxic and/or volatile contaminants in the polymeric films and articles thereof. In some embodiments, methods are provided for recycling latex paint into polymeric films that meet environmental and/or safety regulations. In some embodiments, methods are provided for treating latex paint to reduce, remove, or neutralize volatile organic compounds (VOCs), ethylene glycol, anti-freeze agents, and/or related compounds, optionally while controlling particle size distribution, to provide treated latex paint suitable for use in production of polymeric films via continuous film-making processes such as extrusion processes, e.g., blown film extrusion or cast film extrusion. In some embodiments, such treated latex paint is free of detectable amounts of solvent and/or odorless.

In a first aspect, there are provided polymeric film or sheet structures comprising treated latex paint and one or more water-insoluble polymer component, wherein the treated latex paint comprises at least one latex paint polymer, and the one or more water-insoluble polymer component is immiscible with the treated latex paint. In an embodiment, a polymeric film has a thickness of less than about 4 mils. In another embodiment, a polymeric film comprises no more than trace amounts of ethylene glycol. In yet another embodiment, a polymeric film is prepared using a continuous film-making process such as an extrusion process, e.g., blown film extrusion, blown film coextrusion, cast film extrusion, or cast film coextrusion.

In some embodiments, the one or more water-insoluble polymer component is selected from the group consisting of polyolefins, and combinations thereof. A polyolefin may be, for example, a polyethylene homopolymer, a polyethylene copolymer, or a derivative, mixture, or blend thereof. In some embodiments, a polyolefin is low density polyethylene (LDPE), low density polyethylene butene (LLDPE BUTENE), linear low density polyethylene (LLDPE), very low density polyethylene (VLLDPE), very low density polyethylene octene (VLLDPE OCTENE), high density polyethylene (HDPE), a copolymer of ethylene and another hydrocarbon, or a combination thereof. In some embodiments, the one or more water-insoluble polymer component comprises a prime virgin polymer, a non-prime polymer, an off-spec polymer, a recycled polymer or a post-recycled polymer. In some embodiments, the one or more water-insoluble polymer component is a polymer suitable for production of thin films and/or articles thereof via a continuous film-making process or an extrusion method. A recycled or post-recycled polymer may be, for example, selected from the group consisting of printed, non-printed, pigmented, and non-pigmented recycled polymers.

In some embodiments, latex paint (e.g., waste latex paint, treated latex paint, etc.) comprises flat latex paint, satin latex paint, gloss latex paint, semi-gloss latex paint, high-gloss latex paint, or a mixture thereof. In some embodiments, latex paint (e.g., waste latex paint) is pigmented. Latex paint generally comprises at least one latex paint polymer. In some embodiments, latex paint polymer comprises one or more polymers selected from the group consisting of acrylate polymers, vinyl acrylate polymers, vinyl acetate polymers, styrene acrylate polymers, polyurethanes, epoxides, polyesters, neoprene, and alkyd polyesters. In some embodiments, latex paint comprises one or more of the following: water, latex polymer binder, filler, color, and ethylene glycol.

In some embodiments, treated latex paint comprises non-reusable waste latex paint.

In some embodiments, treated latex paint is in the form of a latex concentrate. Latex concentrate may comprise, for example, from about 5 to about 70 wt. % of treated latex paint, or from about 1 to about 35 wt. % of treated latex paint. In some embodiments, latex concentrate comprises at least about 30 wt. %), at least about 40 wt. %, at least about 50 wt. %, at least about 60 wt. %), at least about 70 wt. %, at least about 80 wt. %, at least about 90 wt. %, at least about 95 wt. %), or at least about 99 wt. % of one or more water-insoluble polymer component.

A polymeric film of the invention may comprise from about 1 to about 100 wt. % of treated latex paint in the form of latex concentrate. In some embodiments, a polymeric film comprises at least about 50 wt. %, at least about 60 wt. %, at least about 70 wt. %, at least about 80 wt. %, at least about 90 wt. %, at least about 95 wt. %, or at least about 99 wt. % of treated latex paint. In some embodiments, a polymeric film of the invention may comprise from about 1 to about 99 wt. % of treated latex paint.

In some embodiments, a polymeric film of the invention comprises treated latex paint in the form of a latex dry blend. In some embodiments, a latex dry blend comprises about 1 to about 100 wt. % of treated latex paint. In some embodiments, a premix comprises about 1 to about 100 wt. % of treated latex paint.

In some embodiments, a polymeric film of the invention comprises no more than trace amounts of ethylene glycol. In some embodiments, polymeric film comprises no more than 1 wt. % of ethylene glycol; from about 0.1 to about 0.3 wt. % of ethylene glycol; or about 0.1 wt. % of ethylene glycol. In some embodiments, treated latex paint comprises no more than trace amounts of ethylene glycol, or treated latex paint comprises no more than 1 wt. % of ethylene glycol; from about 0.1 to about 0.3 wt. % of ethylene glycol; or about 0.1 wt. % of ethylene glycol.

In some embodiments, volatile organic compounds (VOCs) and/or ethylene glycol have been substantially removed from treated latex paint. Treated latex paint may be treated chemically to esterify or oxidize ethylene glycol, for example with a carboxylic acid to esterify ethylene glycol. In some embodiments, treated latex paint has been treated with stearic acid, acetic acid, adipic acid, capric acid, lauric acid, myristic acid, palmitic acid, or propanoic acid. In some embodiments, treated latex paint has been treated by heating to remove VOCs. For example, treated latex paint may have been subjected to a temperature of about 100° C. or higher, about 200° C. or higher, about 300° C. or higher, about 400° C. or higher, about 500° C. or higher, or to a temperature ranging from about 200° C. to about 500° C. at atmospheric pressure (i.e., under regular ambient pressure conditions). In some embodiments, treated latex paint is further treated with an air neutralizer system after heating to destroy and/or remove VOCs. In some embodiments, the ethylene glycol is propylene glycol or diethylene glycol.

In some embodiments, treated latex paint has a top particle size of about 25 microns or about 45 microns. For example, treated latex paint may have been treated by filtration, screening, and/or milling to remove and/or downsize particles or contaminants greater than about 25 microns to about 45 microns in size. In some embodiments, treated latex paint has a top particle size of about 45 microns. In some embodiments, treated latex paint has a top particle size of about 25 microns, or a particle size in the range of from about 25 microns to about 45 microns.

In some embodiments, a polymeric film is a monolayer film. In other embodiments, a polymeric film is a multilayer film, e.g., comprising at least 3 layers. In some embodiments, one or more layer in a multilayer film is comprised of about 99% treated latex paint. In some embodiments, one or more layer in a multilayer film is comprised of 0% treated latex paint. In some embodiments, one or more layer in a multilayer film comprises about 100 wt. % of latex concentrate. In some embodiments, one or more layer in a multilayer film comprises about 0 wt. % latex concentrate.

In some embodiments, a multilayer film comprises: a) a first outer layer facing earthward, comprising: i) about 40 to 100 wt. % of a water-insoluble polyethylene homopolymer, polyethylene copolymer, or a derivative, mixture or blend thereof; ii) about 0 to 20 wt. % of an additive and/or colorant; and iii) about 0 to 40 wt. % of the treated latex paint; b) at least one middle layer, comprising: i) about 50 to 100 wt. % of a water-insoluble polyethylene homopolymer, polyethylene copolymer, or a derivative, mixture or blend thereof; ii) about 0 to 10 wt. % of an additive and/or colorant; and iii) about 0 to 40 wt. % of the treated latex paint; and c) a second outer layer facing skyward, comprising: i) about 35 to 100 wt. % of a water-insoluble polyethylene homopolymer, polyethylene copolymer, or a derivative, mixture or blend thereof; ii) about 0 to 25 wt. % of an additive and/or colorant; and iii) about 0 to 40 wt. % of the treated latex paint. In some embodiments, the at least one middle layer comprises 0 wt. % of the treated latex paint, for example the at least one middle layer may comprise low density polyethylene (LDPE) and/or high density polyethylene (HDPE), a polyamide resin, or an ethylene vinyl alcohol copolymer.

In some embodiments, the at least one middle layer comprises a plurality of polymeric film sub-layers. In some embodiments, the at least one middle layer is sandwiched between small layers comprising a cyclic anhydride modified polyolefin resin.

In some embodiments, the first outer layer, the at least one middle layer, and/or the second outer layer further comprise one or more colorant and/or additive. In some embodiments where a polymer film is a monolayer, the monolayer further comprises one or more colorant and/or additive. Non-limiting examples of colorants and/or additives include organic pigments, inorganic pigments, dyes, ultraviolet (UV) absorbers, inhibitors, light stabilizers, anti-block agents, slip agents, lubricants, waxes, anti-oxidants, anti-fog agents, compatibilizers, coupling agents, odor neutralizers, odor masking agents, fragrances, desiccants, and/or combinations thereof.

In some embodiments, treated latex paint is in the form of a latex concentrate. In other embodiments, treated latex paint is in the form of a latex dry blend. In some embodiments, treated latex paint may be in the form of a premix, as described herein.

In some embodiments, a polymeric film is in the form of a monolayer, the monolayer film comprising: about 42 to about 99 wt. % of a water-insoluble polyethylene homopolymer, polyethylene copolymer, or a derivative, mixture, or blend thereof; about 0.01 to about 30 wt. % of an additive and/or colorant; and about 1 to about 50 wt. % of latex concentrate, wherein the latex concentrate comprises about 30 to about 95 wt. % water-insoluble polymer component and about 5 to about 70 wt. % treated latex paint. In some embodiments, a monolayer film comprises about 42 to about 99.9 or about 42 to about 99.94 wt. % of a water-insoluble polyethylene homopolymer, polyethylene copolymer, or a derivative, mixture, or blend thereof. In some embodiments, a monolayer film comprises about 0 to about 50 wt. % of a water-insoluble polyethylene homopolymer, polyethylene copolymer, or a derivative, mixture, or blend thereof; and about 50 to about 100 wt. % of latex concentrate, wherein the latex concentrate comprises about 40 to about 98 wt. % water-insoluble polymer component; about 1 to about 25 wt. % of an additive and/or colorant; and about 1 to about 35 wt. % treated latex paint.

In some embodiments, a polymeric film is in the form of a monolayer, the monolayer film comprising: about 42 to about 99 wt. % of a water-insoluble polyethylene homopolymer, polyethylene copolymer, or a derivative, mixture, or blend thereof; about 0.01 to about 30 wt. % of an additive and/or colorant; and about 1 to about 35 wt. % of latex dry blend. In some embodiments, a monolayer film comprises, in part a), about 42 to about 99.9 or about 42 to about 99.94 wt. % of a water-insoluble polyethylene homopolymer, polyethylene copolymer, or a derivative, mixture, or blend thereof.

In some embodiments, a polymeric film is a thin film. In some embodiments, a polymeric film has a thickness of about 10 mils or less, a thickness of from about 0.5 to about 4 mil, from about 0.5 to about 8 mil, or from about 0.8 to about 4 mil. In some embodiments, a polymeric film has a thickness of from about 0.5 to about 2 mil.

In some embodiments, a polymeric film is a multilayer film, the middle layer making up about 40 to about 70% of the film's thickness and the outer layers together making up about 30 to about 60% of the film's thickness.

In another aspect, there are provided methods for preparing treated latex paint for use in recycling waste latex paint in a polymeric film using a continuous film-making process, the method comprising the steps of: a) reducing the initial moisture content of the latex paint to about 30 wt. % or less; b) treating the latex paint to reduce, remove, or neutralize ethylene glycol and/or volatile organic compounds (VOCs); and c) optionally, treating the latex paint to control particle-size distribution and/or top particle size of the latex paint. In some embodiments, methods further comprise a step of drying the latex paint to reduce moisture content to about 0.5 wt. % or less. In some embodiments, moisture content is reduced to about 0.1 wt. % to about 0.5 wt. %. In some embodiments, drying comprises heating at a temperature in the range of about 60° C. to about 600° C., about 100° C. to about 600° C., or in the range of about 200° C. to about 500° C., at atmospheric pressure (i.e., under regular ambient pressure conditions). In some embodiments, moisture content is reduced to about 15 wt. % or less in step a). In some embodiments, moisture content is reduced by liquid-solid separation and/or drying in step a). Liquid-solid separation may comprise, for example, centrifugation, rotary pressure filtration, auto pressing, vacuum belt filtration, vacuum drying, or pressure plate filtration.

In some embodiments, step b) comprises chemical treatment of ethylene glycol. For example, ethylene glycol may be esterified by reaction with a carboxylic acid, such as stearic acid. Ethylene glycol may be reacted with acetic acid, adipic acid, capric acid, lauric acid, myristic acid, palmitic acid, or propanoic acid. In some embodiments, step b) further comprises heat treatment to reduce, remove, or neutralize ethylene glycol and/or VOCs. For example, latex paint may be heated at a temperature in the range of about 100° C. to about 600° C., at atmospheric pressure. In some embodiments, an air neutralizer system is used after heating to remove VOCs. In some embodiments, treated latex paint comprises no more than trace amounts of ethlyene gycol.

Any type of latex paint may be recycled or used in methods provided herein. For example, latex paint may be flat latex paint, satin latex paint, gloss latex paint, semi-gloss latex paint, high-gloss latex paint, or a mixture thereof. In some embodiments, latex paint is pigmented. In some embodiments, latex paint is non-reusable waste latex paint.

In some embodiments, particles or contaminants greater than about 45 microns in size or greater than about 25 microns in size are removed or downsized in step c). Step c) may comprise filtration, screening, and/or milling, for example. In some embodiments, removed particles or contaminants greater than about 45 microns in size are milled to reduce their size to about 45 microns or less, or to about 25 microns or less, and then added back to the treated latex paint. In some embodiments, filtration is performed via compounding or an equivalent process, wherein latex paint in molten form is passed through a screen filtration system, e.g., to filter out particles above about 45 micron in size. A screen filtration system may comprise, for example, a single screen, multiple screens, or a series of fine screens. Screening may comprise, for example, passing latex paint in dried powder form through multiple screens or through a series of screens to remove oversized particles.

In some embodiments, methods provided herein further comprise addition of one or more colorant and/or additive to the latex paint (e.g., the waste latex paint, the treated latex paint, etc.). Non-limiting examples of colorants and/or additives include organic pigments, inorganic pigments, dyes, ultraviolet (UV) absorbers, inhibitors, light stabilizers, anti-block agents, slip agents, lubricants, waxes, anti-oxidants, anti-fog agents, compatibilizers, coupling agents, odor neutralizers, odor masking agents, fragrances, desiccants, and/or combinations thereof.

In some embodiments, there are provided polymeric films made according to methods provided herein, as well as articles made thereof.

In another aspect, there are provided methods for recycling latex paint in a polymeric film, comprising the steps of: a) preparing treated latex paint, as described; and b) preparing a polymeric film from the treated latex paint, in combination with one or more water-insoluble polymer component immiscible with the treated latex paint, using a continuous film-making process. In some embodiments, methods further comprise a step of mixing and/or compounding the treated latex paint with the one or more water-insoluble polymer component prior to the step of preparing the polymeric film using a continuous film-making process. In other embodiments, the treated latex paint and the one or more water-insoluble polymer component are combined during the step of preparing the polymeric film using a continuous film-making process. A continuous film-making process may be, for example, an extrusion process. Non-limiting examples of such processes include blown film extrusion, blown film coextrusion, cast film extrusion, and cast film coextrusion. In some embodiments, non-reusable waste latex paint is recycled in a polymeric film using the methods described herein.

In some embodiments, the step of mixing and/or compounding comprises mixing treated latex paint with one or more water-insoluble polymer component, and compounding the mix using a single screw extruder, a twin screw extruder or equivalent equipment with the capability of melting, mixing, metering, degassing and dispersing the mix. In some embodiments, the mix is pelletized using a water, air, or dry pelletizing system. In some embodiments, the step of mixing and/or compounding comprises mixing treated latex paint with one or more water-insoluble polymer component, forming a latex concentrate. In other embodiments, the step of mixing comprises mixing treated latex paint with one or more water-insoluble polymer component using a hot/cold jacketed high intensity shear mixer to form a latex dry blend. Alternative batch mixing or continuous mixing (e.g., using a continuous or semi-continuous mixing device) may be used.

Polymeric films of the invention or made using methods provided herein may be comprised partially or fully of latex dry blend or of latex concentrate.

In some embodiments, the one or more polymer component is a carrier resin. In some embodiments, a carrier resin comprises a polymer suitable for production of a thin film using a continuous film-making process, e.g., an extrusion process. In some embodiments, a carrier resin comprises a polymer suitable for production of a latex concentrate. Non-limiting examples of carrier resins include homopolymers, copolymers, waxes, copolymers of ethylene and another hydrocarbon, derivatives thereof, and/or combinations thereof. In some embodiments, a carrier resin comprises a prime virgin polymer, a non-prime polymer, an off-spec polymer, a recycled polymer or a post-recycled polymer. A recycled or post-recycled polymer may be, for example, a printed, non-printed, pigmented, and non-pigmented recycled polymer.

In some embodiments, methods described herein further comprise a step of adding one or more colorant and/or additive. Non-limiting examples of colorants and/or additives include organic pigments, inorganic pigments, dyes, ultraviolet (UV) absorbers, inhibitors, light stabilizers, anti-block agents, slip agents, lubricants, waxes, anti-oxidants, anti-fog agents, compatibilizers, coupling agents, odor neutralizers, odor masking agents, fragrances, desiccants, and/or combinations thereof.

Methods described herein may be used to form monolayer or multilayer polymeric films. A multilayer film may comprise at least three layers. In some embodiments, each of the at least three layers comprises treated latex paint. In other embodiments, only one of the at least three layers comprises treated latex paint. In further embodiments, one or more layer comprises treated latex paint.

In some embodiments, polymeric film has a thickness of about 0.5 to about 8 mils. A polymeric film may have, for example, a thickness of about 0.8 to about 4 mils, or of about 4 mils or less. In some embodiments, a polymeric film comprises three layers, the middle layer comprising the treated latex paint and making up about 40 to about 70 percent of the total thickness of the polymeric film, the two outer layers being free of the treated latex paint and together making up about 30 to about 60 percent of the total thickness of the polymeric film. In other embodiments, a polymeric film comprises three layers, the middle layer being free of the treated latex paint and making up about 40 to about 70 percent of the total thickness of the polymeric film, and the two outer layers comprising the treated latex paint and together making up about 30 to about 60 percent of the total thickness of the polymeric film.

In some embodiments, a polymeric film has a smooth surface. In some embodiments, a polymeric film's surface may be embossed to form a textured surface. A film's surface may also be treated followed by a step of lamination or vacuum metallization of the film's surface.

In some embodiments, methods described herein further comprise a step of forming an article from a polymeric film of the invention.

In another aspect, there are provided herein articles comprising a polymeric film of the invention, or made using methods described herein. An article may be, for example, an area-measured plastic article. Non-limiting examples of articles include plastic bags (e.g., garbage bags, merchandise bags, cement bags, grocery sacks, etc.), industrial liners, agricultural films, shrink films, and flexible packaging. In some embodiments, an article is about 0.5 to about 8 mils in thickness. In some embodiments, an article is about 0.8 to about 4 mils in thickness. In some embodiments, an article comprises no more than 1 wt. % of ethylene glycol; from about 0.1 to about 0.3 wt. % of ethylene glycol; about 0.1 wt. % of ethylene glycol; or no more than trace amounts of ethylene glycol.

### BRIEF DESCRIPTION OF THE DRAWINGS

The foregoing and other features will become more apparent upon reading of the following non-restrictive description of illustrative embodiments, given by way of example only with reference to the accompanying drawings. Like numerals represent like features in the various drawings.

For a better understanding of the present technology, as well as other aspects and further features thereof, reference is made to the following description which is to be used in conjunction with the accompanying drawings, where:

FIG. 1 is a schematic cross-sectional view of a multilayer film in accordance with one embodiment.

FIG. 2 is a schematic cross-sectional view of a multilayer film having sub-layers in its middle layer in accordance with one embodiment.

FIG. 3 is a schematic diagram depicting a method 300, the method 300 being implemented in accordance with non-limiting embodiments of the present technology.

### DETAILED DESCRIPTION

The description that follows is intended to be only a description of illustrative examples of the present technology. This description is not intended to define the scope or set forth the bounds of the present technology. In some cases, what are believed to be helpful examples of the methods and systems provided herein may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition it is to be understood that the methods and systems described herein may provide in certain instances simple implementations of the present technology, and that where such is the case they have been presented in this manner as an aid to understanding. As persons skilled in the art would understand, various implementations of the present technology may be of a greater complexity.

There are provided herein methods and systems for recycling waste latex paint into film or sheet structures, and articles produced from such film or sheet structures. In an embodiment, there is provided a process of recycling latex paint in a polymeric film, the film comprising treated latex paint and one or more water-insoluble polymer component. In some embodiments, there is provided a latex concentrate comprising a melt-blended extrudate of treated latex paint optionally with one or more water-insoluble polymer component. In some embodiments, there is provided a latex dry blend comprising treated latex paint optionally with or without the addition of one or more water-insoluble polymer component.

As used herein, the term “treated latex paint” is used to refer to waste or recycled latex paint that has been reconditioned or has undergone at least one treatment in order to be suitable for use in production of a film, or an article thereof, via a continuous film-making process, e.g., an extrusion method such as blown film extrusion or cast film extrusion. It should be understood that a treated latex paint comprises at least one latex paint polymer. Treated latex paint is thus prepared by reconditioning or treating waste or recycled latex paint according to methods provided herein. For example, latex paint may be dried; may undergo a particle-size distribution and/or top particle size control process; may be treated to remove or to chemically inactivate ethylene glycol and/or other volatile organic compounds (VOCs), or to transform ethylene glycol and/or other VOCs to a safer chemical; and/or may undergo other processes, as required, to make the treated latex paint suitable for use in production of a film using a continuous film-making process. In some embodiments, one or more additive is added to latex paint during treatment. Methods of treating waste latex paint to prepare the treated latex paint are described in further detail below.

Waste latex paint may be collected from a waste treatment facility or directly from the unwanted supply of a retailer or consumer. Paint may be collected in liquid, wet, or partially dried form, or a combination thereof. In one embodiment, paint is collected in liquid form and dried to reduce water, VOCs, ethylene glycol, and/or solvent content prior to further treatment and/or melt-blending with one or more water-insoluble polymer component. In some embodiments, paint is collected in liquid form, treated to separate out solids, and then treated further to reduce moisture content.

In some embodiments, waste latex paint is non-reusable paint. Paint reuse is not always possible or cost effective due to the unsuitable quality of the waste latex paint, which can result from bacterial growth, curing, oxidation, etc. In some embodiments, treated latex paint is prepared by treating non-reusable waste latex paint. In some embodiments, there are provided methods for recycling non-reusable waste latex paint in a polymeric film.

Latex paint composition varies depending on the application, color, and cost. Typically, latex paint is composed mainly of water, latex polymer such as acrylic, styrene acrylic, vinyl acrylic, acrylic copolymer, or vinyl acetate ethylene, titanium dioxide pigment, other pigments and colorants, ethylene glycol and/or other anti-freeze agents, and possibly fillers such as kaolin and calcium carbonate. It should be understood that many types of latex paint are known and may be treated and used to prepare films and articles thereof according to methods described herein. In some embodiments, latex paint or waste latex paint is pigmented. In some embodiments, latex paint or waste latex paint is flat latex paint, satin latex paint, gloss latex paint, semi-gloss latex paint, high-gloss latex paint, or a mixture thereof. Latex paint or waste latex paint may comprise, for example, acrylic, vinyl, and/or rubber polymer. Non-limiting examples of latex paint polymers include acrylates, vinyl acrylates, vinyl acetates, styrene acrylates, polyesters, alkyd polyesters, epoxides, and neoprene. It should be understood that treated latex paint may comprise one or more type of latex paint or waste latex paint.

In some embodiments, treated latex paint comprises one or more additive. It may be desirable to add certain agents to treated latex paint in order to achieve certain desired properties in a film or sheet structure or article thereof. Non-limiting examples of additives include colorants, primary amides, secondary amides, slip agents and derivatives thereof (e.g., amides, oleamide, stearamide), organic antiblocks, inorganic antiblocks (e.g., based on amorphous and/or crystalline silicates or Kaolin), ultraviolet (UV) absorbers, light stabilizers, lubricants (e.g., polyolefine waxes, PE waxes and PP waxes and metal stearates), anti-oxidants, anti-fog agents (e.g., glycerol esters of fatty acids, alkoxylated alkyl phenols, and polyalkoxylated fatty acid esters), metal stearates, waxes, coupling agents (e.g., maleic anhydrides, anhydride modified polyethylene, zirconates, titanates, aluminates, and silanes), compatibilizers (e.g., ethylene copolymers, and sodium ionomers), odor neutralizers and/or odor masking agents (e.g., a zinc salt of ricinoleic acid, activated carbon, magnesium oxide, amorphous sodium potassium aluminum silicate, magnesium sulfate, a plant extract, cyclohexaamylose, esters, and fragrances), desiccants (e.g., calcium oxide, bentonite clay, silica gels, and zeolite), and combinations thereof. It will be appreciated by the skilled artisan that other additives may be used and will be chosen based on any of several factors, such as the desired properties and characteristics of a film or an article made from the film, the characteristics of the latex paint, etc.

As used herein, a “water-insoluble polymer component” refers to a water-insoluble polymer immiscible with treated latex paint. It should be understood that any water-insoluble polymer that can withstand fabrication to a film or article thereof according to methods described herein, e.g., that can withstand film-making using a continuous film-making process, may be used. Non-limiting examples of such water-insoluble polymers include polyolefins, polyethylene homo- and/or co-polymers such as low density polyethylene (LDPE), high density polyethylene (HDPE), and linear low density polyethylene (LLDPE), copolymers of ethylene and another hydrocarbon (e.g., ethylene vinyl acetate (EVA), ethylene acrylic acid (EAA), and/or a blend thereof), and combinations thereof. LLDPE refers to copolymers of ethylene with one or more comonomers (selected, for example, from C4 to C10 alpha-olefins such as butene-1 or octane).

In some embodiments, a water-insoluble polymer component is a carrier resin suitable for film-making using a continuous film-making process. In some embodiments, a water-insoluble polymer component is a carrier resin suitable for use in making a latex concentrate. Non-limiting examples of carrier resin(s) include homopolymers, copolymers, waxes, biopolymers, and derivatives and/or mixtures thereof.

A water-insoluble polymer component may be from a prime, a virgin, a non-prime, a recycled, a post-recycled, and/or an off-spec source.

In an embodiment, a water-insoluble polymer component is a water-insoluble polyethylene homopolymer, polyethylene copolymer, or a derivative, mixture, or blend thereof.

It should be understood that the form of the treated latex paint is not particularly limited. Treated latex paint may be prepared in several different forms, e.g., dry blend or concentrate. For example, in some embodiments treated latex paint is prepared in the form of a dry blend (referred to herein as a “latex dry blend”). Dry blends comprise simply a mix of ingredients blended together. Dry blends are often prepared before compounding, for example to help the dispersion process at the molten phase in an extrusion process, however it will be understood by the skilled artisan that dry blends do not necessarily require compounding before use in a film-forming process. A latex dry blend may comprise treated latex paint only; a mixture of treated latex paint and one or more additive, if desired; a mixture of treated latex paint and one or more water-insoluble polymer component, if desired; or a mixture of treated latex paint, one or more additive, and one or more water-insoluble polymer component. In some embodiments, the one or more water-insoluble polymer component in a latex dry blend is a carrier resin. In one embodiment, a latex dry blend comprises a colorant. In another embodiment, a latex dry blend comprises one or more water-insoluble′ polymer component, e.g., a carrier resin. In yet another embodiment, a latex dry blend comprises treated latex paint and optionally one or more additive and does not comprise a water-insoluble polymer component.

In alternative embodiments, treated latex paint is prepared in the form of a concentrate (referred to herein as a “latex concentrate”). A latex concentrate is prepared by homogenizing, dispersing, etc. the various ingredients together in an extrusion or equivalent process (in contrast to a latex dry blend, which is mixed and not molten). It will be understood by the skilled artisan that such an extrusion or equivalent process is a process capable of melting, mixing, metering, degassing, and/or dispersing the various ingredients. Typically, in a latex concentrate active ingredients are encapsulated within a molten polymeric matrix, which is suitable for further compounding and/or film-making using a continuous film-making process such as blown film or cast film extrusion. A latex concentrate may comprise, in some embodiments, a mixture of treated latex paint and one or more water-insoluble polymer component, if desired; or a mixture of treated latex paint, one or more additive, and one or more water-insoluble polymer component. In some embodiments, the one or more water-insoluble polymer component in a latex concentrate is a carrier resin. In one embodiment, a latex concentrate comprises a colorant. In another embodiment, a latex concentrate comprises one or more water-insoluble polymer component, e.g., a carrier resin. In yet another embodiment, a latex concentrate comprises treated latex paint, optionally one or more additive, and a water-insoluble polymer component. A compounded latex concentrate may have a spherical, cylindrical, or irregular form, or may be in a pulverized, flaky, or particulate form, depending on how it is compounded. It will be understood by the skilled artisan that the final shape and geometry of a compounded latex concentrate will vary depending on the tools, equipment, and methods used.

It should be understood, therefore, that treated latex paint in various forms may be used in the film-making process, and that the treated latex paint and the one or more water-insoluble polymer component may be blended together at different steps in a continuous film-making process. For example, the treated latex paint and the one or more water-insoluble polymer component may be blended together prior to a continuous film-making process, or during a continuous film-making process. For example, one or more water-insoluble polymer component may be mixed together with a latex dry blend or a latex concentrate, which is then used in a continuous film-making process. Alternatively, a latex dry blend may not comprise a water-insoluble polymer component; in this case, the treated latex paint in the form of a latex dry blend and the water-insoluble polymer component are added separately during a continuous film-making process. The skilled artisan will recognize that many such permutations are possible, and are intended to be encompassed by methods described herein.

In an embodiment, a latex concentrate comprises from about 0.1% to about 40%, or from about 1% to about 40%, or from about 1% to about 70% by weight of treated latex paint. In an embodiment, a latex concentrate comprises up to about 40% by weight of treated latex paint. In another embodiment, a latex concentrate comprises up to about 70% by weight of treated latex paint.

In an embodiment, a latex dry blend comprises from about 0.1% to about 40%, or from about 1% to about 40%, or from about 1% to about 70%, or from about 1% to 100% by weight of treated latex paint. In an embodiment, a latex dry blend comprises up to about 40% by weight of treated latex paint. In another embodiment, a latex dry blend comprises up to about 70% by weight of treated latex paint. In yet another embodiment, a latex dry blend comprises from about 1% to about 100% by weight of treated latex paint.

The terms “percent (%) by weight (wt.)” and “wt. %” are used interchangeably herein.

As used herein, the term “film” refers to a continuous polymeric material produced using a continuous process, and encompasses films, thin films, sheets and sheet structures. The terms “film” and “polymeric film” are used interchangeably herein. A film may be a monolayer or may comprise multiple layers, e.g., two or more layers, three or more layers, etc. In an embodiment, a polymeric film comprises at least 3 layers, one or more of the layers comprising treated latex paint and one or more water-insoluble polymer component. In some embodiments, a polymeric film is a thin film, i.e., a film having a thickness of about 10 mil or less, or about 4 mil or less. In some embodiments, a film has a thickness of from about 0.5 to about 4 mil, from about 0.5 to about 8 mil, from about 0.8 to about 4 mil, or from about 0.5 to about 2 mil. In some embodiments, a film has a thickness of less than about 4 mil. In some embodiments, a polymeric film is a monolayer having a thickness of about 0.5 to about 8 mils, or of about 0.8 to about 4 mils. Films may be made using a variety of continuous film-making processes, such as but not limited to blown film extrusion, blown film coextrusion, cast film extrusion, and cast film coextrusion.

There are also provided herein articles comprising polymeric films, as described herein, and articles made using methods and systems described herein. It will be appreciated that polymeric films have a wide range of application. For example, polymeric films may be used to make flexible packaging articles, bags (e.g., merchandise bags, garbage bags, trash bags, bags for soil, bags for compost, bags for cement, grocery sacks, etc.), shrink films, agricultural films (e.g., crop films), and/or industrial liners. Articles may be used directly by end users, by consumers, by retailers, and/or by industry. In an embodiment, there are provided garbage bags comprising a polymeric film as described herein. In another embodiment, there are provided garbage bags comprising treated latex paint and one or more water-insoluble polymer component as described herein. In some embodiments, polymeric films and articles thereof such as bags comprise no more than trace amounts of ethylene glycol.

As used herein, a “trace amount” refers to an amount that is just detectable and difficult to measure, i.e., a very small amount that is able to be detected using known analytical techniques but not able to be quantified. In some embodiments, polymeric films and articles thereof contain no detectable ethylene glycol, or only a trace amount of ethylene glycol. In some embodiments, articles provided herein comprise no more than 1 wt. % of ethylene glycol, or comprise from about 0.1 wt. % to about 0.3 wt. % of ethylene glycol, or comprise about 0.5 wt. % or less of ethylene glycol, or comprise about 0.1 wt. % or less of ethylene glycol. In some embodiments, polymeric films and articles thereof such as bags comprise no more than trace amounts of a VOC. In an embodiment, there is provided a polymeric film comprising a treated latex paint, one or more water-insoluble polymer component, and no more than a trace amount of ethylene glycol and/or no more than a trace amount of a VOC. In one embodiment, there is provided a garbage bag comprising a treated latex paint, one or more water-insoluble polymer component, and no more than a trace amount of ethylene glycol and/or no more than a trace amount of a VOC.

As used herein, “ethylene glycol” includes derivatives, analogs, and byproducts of ethylene glycol that are used as, e.g., antifreeze, or are commonly found in latex paint, such as, without limitation, diethylene glycol, triethylene glycol, tetraethylene glycol, and propylene glycol.

There are further provided herein processes for recycling latex paint in a polymeric film. For example, various chemical and physical treatment processes are provided. These processes typically include several steps, as described further below. It should be understood that, depending on: the characteristics of the starting latex paint (for example, the type of latex paint; whether it is in liquid form or partially dry; its chemical composition; whether it has a bad smell or not); the processing requirements; and/or the desired properties of the end product, one or more steps may be omitted, as will be determined by the skilled artisan. Further, the order of the steps may be changed, as deemed appropriate by the skilled artisan. These steps are intended to be illustrative and not limiting, as the process will be adjusted depending on the starting latex paint and the desired properties of the end product. The steps in an exemplary process are as follows:

A. First, latex paint (e.g., waste latex paint) is optionally sorted to separate paint in liquid form (typically a thick viscous liquid, referred to herein as “liquid paint”) from dried paint (including partially pre-dried paste, referred to herein as “wet paint”). Paint may also be in pre-dried, particulate form. Waste latex paint may also be identified chemically using information provided, such as information received from a waste treatment facility, a retailer, or a consumer, or information obtained using a chemical analytical method to identify the main components of the waste latex paint. Such analytical methods are well-known in the art.

B. Liquid paint is optionally subjected to an initial liquid-solid separation process to reduce overall moisture content, e.g., to between about 15 to about 30 wt. %, to between about 15 to about 25 wt. %, to about 30 wt % or less, to about 25 wt % or less, or to about 15 wt. % or less. Many such processes are known in the art, including without limitation centrifugation, rotary pressure filtration, auto pressing, vacuum belt filtration, vacuum drying, and pressure plate filtration systems.

C. Liquid paint is then treated to reduce, remove, or neutralize ethylene glycol and/or volatile organic compounds (VOCs). In an embodiment, liquid paint is subjected to chemical treatment to reduce, remove or neutralize ethylene glycol and/or VOCs. Wet paint may also be subjected to chemical treatment and may be treated along with the liquid paint at this stage, if desired; alternatively, wet paint may be treated separately. It will be understood by the skilled artisan that chemical treatment is generally conducted in a suitable vessel, e.g., a reactor or mixer such as a batch reactor, a hot/cold jacketed high/low shear intensity mixer, a semi-continuous stirred tank reactor, or a plug flow tubular reactor.

In an embodiment, an esterification reaction is carried out between ethylene glycol and a carboxylic acid, such as stearic acid, in the presence of a strong catalyst, such as Amberlyst™ 36, to produce glycol stearate and glycol distearate (relative yields are determined by the molar ratio of acid to glycol). Ethylene glycol may also be reacted with other organic acids and using other methods. For example, ethylene glycol can be reacted in etherification reactions to form mono and diethers, can undergo oxidation reactions with inorganic acids such as nitric acid to form glyoxal, which can further react with other derivatives and form 1,3-Dioxolane, 1,4-Dioxane, and so on.

In some embodiments, supplemental additives and/or catalysts are added to the reaction vessel at this stage. It will be understood by the skilled artisan that the desired weight percentage of each component can be controlled using, for example, gain in weight or loss in weight automated feeding systems. For example, the mix may first undergo a cold mixing process for adequate time to ensure sufficient distribution of the mix at an appropriate mixing speed with proper mixing configurations, as will be determined by the skilled artisan using common general knowledge in the art. The temperature of the mixing vessel is set to create sufficient heating conditions to start the esterification reaction. In an embodiment, the temperature of the mixing vessel is from about 340 K to about 370 K. Mixing speed and duration are adjusted as required to provide proper thermal distribution and adequate dispersion of the viscous mix. The skilled artisan appreciates that other possible temperature settings and reaction kinetics may be used depending on the catalyst, reactants, molar ratios, and end product desired, and will adjust reaction conditions accordingly.

In alternative embodiments, in place of chemical treatment, or in addition to such treatment, liquid paint and/or wet paint is subjected to high temperatures to transform heat-sensitive solid and liquid contaminants in the paint into the gaseous state. For example, paint may be subjected to temperatures above 100° C., temperatures in the range of about 200° C. to about 500° C., or temperatures of about 500° C. or higher at atmospheric pressure (i.e., under regular ambient pressure conditions). In an embodiment, a latex paint composition is subjected to temperatures of 100° C. or higher, 200° C. or higher, 300° C. or higher, 400° C. or higher, 500° C. or higher, or to temperatures ranging from about 200° C. to about 500° C. at atmospheric pressure (i.e., under regular ambient pressure conditions). A skilled artisan will select an appropriate temperature based on VOCs present in a latex paint composition and other considerations known in the art.

It should be understood that such elevated temperatures may transform solid and liquid contaminants into the gaseous state, making it advantageous, in some cases (e.g., if the gases are hazardous), to expose such gases to an air neutralizer system. Thus, in some embodiments, gases produced by heating paint are exposed to air neutralizer system(s), which break down VOCs thermally, chemically (e.g., by chemical reaction with a catalyst), and/or by radiation. Examples of such air neutralizer systems include without limitation: high energy “Non-Thermal Plasma” (NTP) technology combined with an integral catalyst, thermal oxidizers, regenerative thermal oxidizers, catalytic oxidizers, regenerative catalytic oxidizers, direct fired thermal oxidizers, and/or photocatalytic oxidizers. Such air neutralizer systems can be used to breakdown hazardous VOCs thermally, by radiation, and/or by chemical reaction with a catalyst. For example, many VOCs found in latex paint are hydrocarbon based and can be destroyed by thermal combustion, typically producing carbon dioxide (CO₂) and water (H₂O).

D. The chemical- and/or heat-treated latex paint from step C. then undergoes an optional second drying process in order to reduce further volatiles and moisture content. In an embodiment, moisture content is reduced at this stage to about 0.10 to about 0.50 wt. %, to about 0.5 wt. % or less, or to about 0.1 to about 0.5 wt. %. It will be understood by the skilled artisan that this drying step may be carried out by a batch, a continuous, or a semi-continuous system, such as by using a flash dryer, a spray dryer, a vacuum dryer, a conduction dryer, or a fluidized bed dryer. Other known methods may be used. In one embodiment, the latex paint is dried at a temperature in the range of about 200° C. to about 500° C. at atmospheric pressure. The appropriate temperature and drying residence time will be determined by the skilled artisan based on characteristics and properties of the latex paint utilized.

E. Next, dried latex paint is treated to control particle size distribution and/or top particle size. In an embodiment, the dried latex paint is passed through a series of fine screen filtration systems to separate out oversized particles and contaminants above about 45 microns. In another embodiment, the dried latex paint is passed through a series of fine screen filtration systems to separate out oversized particles and contaminants above about 25 microns. In one embodiment, particles greater than about 45 microns are excluded from the treated latex paint, and/or from use in the polymeric film making process. In another embodiment, particles greater than about 25 microns are excluded from the treated latex paint, and/or from use in the polymeric film making process. In some embodiments, particles and contaminants above about 45 microns or above about 25 microns are removed and/or downsized. In an embodiment, the dried latex paint is in a dry powdered form. In some embodiments, the excluded oversized particles are downsized, e.g., milled, to reduce their size further to between about 2 to about 45 microns, or to about 45 microns or less or to about 25 microns or less. Such excluded oversized particles may include, for example, contaminants, pigments, and/or immiscible latex polymers. In alternative embodiments, excluded oversized particles are disposed of, for example, as solid waste paint according to national and local regulations.

In other embodiments, particle size may be controlled by filtering out oversized particles from a molten polymer mixture or blend using a single filtration system; multiple filtration systems; or a series of fine screen filtration systems, for example via extrusion, compounding, and/or an equivalent related process.

The treated latex paint from step E. is an example of a treated latex paint of the invention, comprising waste latex paint that has been treated to render it suitable for use in preparation of a polymeric film or sheet structure according to methods described herein, e.g., according to continuous methods such as blown film or cast film extrusion.

F. Next, the treated latex paint from step E. is optionally pre-mixed with additives and/or colorants in a formulation process prior to compounding, to form a premix. Supplemental additives (e.g., odor neutralizers, odor masking agents, compatibilizers, coupling agents, etc.), carrier resins, pigments, and/or thermoplastic polymers may be added at this stage, as desired. It will be understood by the skilled artisan that many techniques and devices may be used at this step to mix or blend the ingredients. For example, a hot/cold jacketed high shear intensity mixer may be used, in a batch, continuous, or semi-continuous process. It will be understood that the materials (e.g., treated latex paint and supplemental additives, carrier resins, pigments, and/or thermoplastic polymers, as desired) are typically added to a mixing vessel or a blender. Weight percentage of each component can be controlled using, for example, gain in weight or loss in weight automated feeding systems. The mix may then undergo either a cold or hot mixing process (or both) for a time adequate to ensure sufficient distribution and preliminary dispersion of the premix at an appropriate mixing speed with proper mixing blade configurations.

In alternative embodiments, the step F. of pre-mixing is skipped, and the treated latex paint from step E. is compounded directly. For example, depending on the compounding technique used, the treated latex paint may be fed directly through a side feeding system during a compounding process.

In alternative embodiments, the step F. of pre-mixing is skipped, and the treated latex paint from step E. is used directly as a latex dry blend in a continuous film-forming process according to methods described herein. In some embodiments, the premix from step F. is used directly as a latex dry blend in a continuous film-forming process.

G. The premix from step F. or the treated latex paint from step E. (if pre-mixing is skipped) optionally undergoes a compounding process to form a latex concentrate. At this step, in some embodiments, one or more water-insoluble polymer component (i.e., one or more water-insoluble polymer immiscible with the treated latex paint) is added. The premix from step F. or the treated latex paint from step E. is transferred to the appropriate equipment for compounding, e.g., single or twin extruders or equivalent equipment capable of melting, mixing, metering, degassing, and/or dispersing the treated latex paint. The premix material can be fed directly through the main feed hopper using, e.g., volumetric feeders, gravimetric feeders, starve feeding or direct feeding system(s). In some embodiments, the premix material or the treated latex paint can be fed using side feeders. In some embodiments, a molten treated-latex paint/water-insoluble-polymer mix is passed through a screening or filtration process at this stage to ensure that it is free of large contaminants, e.g., contaminants greater than 45 microns in size.

Molten treated-latex-paint/water-insoluble-polymer mix passes through an exiting die to be pelletized accordingly. It will be appreciated by the skilled artisan that water, air or dried pelletizing systems can be used, and the final latex concentrate can be produced in spherical, cylindrical, or irregular pellet form, or in pulverized, flaky, or particulate form. A skilled artisan will be able to carry out different variations to the final shape and geometry of the pelletized latex concentrate depending on tools, equipment, and methods used. In some embodiments, a latex concentrate is pelletized using conventional water pelletizing system(s) to cool molten polymer. In alternative embodiments, dry cooling methods are used. Non-limiting examples of dry cooling methods include convection heat transfer using dry air, nitrogen gas, carbon dioxide gas, etc., conduction heat transfer using cooling jackets, and a combination of both techniques. In some embodiments, dry cooling methods are more environmentally friendly than other conventional pelletizing methods that could potentially contaminate the water stream in contact with a molten latex concentrate during the compounding process.

It should be understood that in some embodiments, treated latex paint and one or more polymer component, e.g., a carrier resin, are blended together during compounding to produce a latex concentrate comprising treated latex paint and one or more polymer component, prior to use of the latex concentrate in preparation of a polymeric film or article thereof. In other embodiments, latex concentrate and one or more water-insoluble polymer component are blended together during production of the polymeric film or article thereof using a continuous film-making process.

A skilled artisan will also appreciate that many conventional compounding methods are known and may be varied depending on product and process requirements. For example, conventional methods using single and/or twin extruders may be carried out using different screw configurations and various downstream equipment such as die face, strand pelletizing, dry air pelletizing, and underwater pelletizing systems. Compounding may be performed using single, twin extruders or equivalent equipment with the capability of melting, metering, degassing, and/or dispersing a polymer mix via hot melt extrusion, involving molten polymers. Depending on the nature of the material being processed, the devolatalising process using single or multiple vacuum venting port systems will vary, depending also on technical limitations regarding how much volatility, oil, and/or moisture can be extracted during the compounding process. The process used to form a polymeric film (blown film extrusion, cast film extrusion, etc.) and the polymer type will also determine the maximum allowable volatilities in a defined process. In some cases, in specific applications, pre-drying or pre-treatment processes are required prior to the compounding process.

It should be understood that in some embodiments, the compounding step G. is omitted, and the premix material from step F. or the treated latex paint from step E. is used directly for the preparation of polymeric film or sheet structures, for example using a side feeding approach, in accordance with methods described herein. In some embodiments, the premix from step F is used directly, along with one or more water-insoluble polymer component, in the preparation of polymeric film or sheet structures. In some embodiments, the treated latex paint from step E. and one or more water-insoluble polymer component are blended together during the preparation of a polymeric film using a continuous film-making process. In some embodiments, treated latex paint and one or more water-insoluble polymer component are blended together prior to use in a continuous film-forming process.

In some embodiments, a hot/cold jacketed high intensity shear mixing unit is used to prepare a latex dry blend from the treated latex paint from step E. A latex dry blend may be used directly in the preparation of polymeric films or sheets using, for example, a side feeding approach, wherein single or multiple side feeders enable the feeding of powdered latex dry blends, as well as fillers, additives, etc. as desired, into the process section of a single, twin extruder, or equivalent equipment. The final composition of a polymeric film may thus be composed partially of a latex dry blend. Alternatively, batch mixers and/or continuous (or semi-continuous) mixing devices may be used, if further treatment of a latex dry blend is desired before its use in a continuous film-forming process. Thus in some embodiments, there are provided latex dry blends suitable for use with one or more water-insoluble polymer component in the preparation of polymeric film or sheet structures. In some embodiments, a latex dry blend comprises one or more water-insoluble polymer component immiscible with the treated latex paint, e.g., a carrier resin(s). Latex dry blends can be used directly in a continuous film-making process to form a polymeric film without the need for more conventional compounding (e.g., via hot-melt extrusion) or pelletizing. In some embodiments, use of latex dry blends is more economical than compounding with other methods such as hot melt extrusion, depending on the materials, tools, and equipment used, and desired characteristics of the final process. It should be understood that films and articles made using such approaches may be composed partially of a latex dry blend.

In methods provided herein, polymeric films and/or articles thereof are prepared using a continuous film-making process, such as but not limited to extrusion, e.g., blown film extrusion, blown film coextrusion, cast film extrusion, and/or cast film coextrusion. Other similar continuous methods may also be used.

Multilayer structures are often prepared by coextrusion. Coextrusion refers to extrusion of one or more materials simultaneously through a single die by arranging the orifices in the die such that the layers merge together before cooling. Coextrusion may be, for example, cast coextrusion or blown coextrusion. Cast coextrusion is a high volume manufacturing process in which raw plastic material is melted and formed into a continuous profile inside an extruder followed by cooling of the produced flat film by chill rolls or water. Blown film coextrusion involves extruding a tube of molten polymer through a die and inflating to several times its initial diameter to form a thin film bubble. This bubble is cooled by air, then collapsed and used as a lay-flat film, or can be made into bags.

Cast film extrusion and blown film extrusion are typically used to prepare a monolayer structure through use of a single extruder to form a tube or a sheet of molten polymer blend through a single layer die followed by a cooling process. In some embodiments, blown film extrusion and/or cast film extrusion is used to prepare a polymeric film having a thickness of less than about 10 mils (about 250 microns), or between about 0.50 to about 4 mils (about 12 to about 100 microns). In some embodiments, blown film extrusion is used to produce hollow thin-walled tubes having a wall thickness of about 0.5 to about 2 mil (about 12 to about 50 microns) which are continuous in length. The continuous tubes can be slit open to form a lay-flat film or sealed and cut into bags, for example.

Blown film extrusion and blown film coextrusion typically require lower processing temperatures than cast extrusion and may therefore be advantageous in some embodiments for processing treated latex paint in the presence of temperature sensitive additives such as odor neutralizers and odor masking agents. However, blown film extrusion typically has a less effective cooling process than flat film, which may be disadvantageous for the processing of temperature sensitive additives in some embodiments. The specific heat capacity of chill rolls or water used in a cast film cooling process is typically significantly higher than the specific heat capacity of air that is used in the blown film cooling process. Thus the cooling efficiency of blown film extrusion and blown film coextrusion could be improved by reducing the temperature of the polymer melt, but this would also reduce productivity and film quality. The skilled artisan will therefore select processing conditions based on the composition of the treated latex paint, desired properties of the end product, and other considerations.

In an embodiment, a multilayered polymeric film is formed via coextrusion of plastic melt for each number of layers, usually vertically, through a circular die, to form a thin walled tube. The tube of the multilayered film then continues upwards, continually cooling, until it passes through nip rolls where the tube is flattened. The flattened film is then either kept as such, or the edges are slit off to produce two flat film sheets or made into bags by sealing across the width of film and cutting or perforating to make each bag.

In another embodiment, a monolayer polymeric film is formed via blown extrusion of plastic melt, usually vertically, through a circular die, to form a thin walled tube. The tube of the monolayer film then continues upwards, continually cooling, until it passes through nip rolls where the tube is flattened. The flattened film is then either kept as such or the edges are slit off to produce two flat film sheets or made into bags by sealing across the width of film and cutting or perforating to make each bag.

In an embodiment, latex dry blend(s) or latex concentrate(s) are fed directly to one or more water-insoluble polymer component, e.g., polyethylene homo- and copolymers, in the feed for the middle layer of a multilayer die. An adequate shear heating and controlled melt temperature extrusion process is accomplished by the appropriate selection of screw configuration capable of providing effective distributive and/or dispersive mixing, yet concomitant very-low temperature rises in the material. Furthermore, in an embodiment, the middle layer of a multilayered film comprises polyethylene homo- and/or co-polymers, or a derivative, mixture or blend thereof, that are able to be processed with melt flow index (MFI) ranging in value from about half (0.5) to about twenty (20) MFI, or from about one (1) to about five (5) MFI.

It will be appreciated by the skilled artisan that every die head has a working range of die inserts at different diameters to suit the required application. Different die gaps can also be specified depending on the material being extruded.

Typically, the blow up ratio (BUR) of a blown film ranges from about 1.5 to about 5.0. The drawdown between the melt wall thickness and the cooled film thickness occurs in both the transverse direction (TD) and the machine direction (MD) and is easily controlled by changing the volume of air inside the bubble and by altering the haul-off speed. In some embodiments, this may be advantageous for blown film, giving a better balance of properties than traditional cast or extruded films which are drawn down in the machine direction only.

In an embodiment, multilayered polymeric films and/or articles thereof, e.g., bags, are from about 0.5 to about 8 mils in thickness, or from about 0.8 to about 4 mils in thickness. In an embodiment, a middle layer comprising treated latex paint accounts for about 40 to about 70 percent of the film or article thickness, while one or more outer treated-latex-paint-free layer accounts for about 30 to about 60 percent of the thickness.

In an embodiment, there are provided multilayered polymeric films and/or articles thereof, e.g., bags, comprising two outer layers comprising a polyolefin polymer blend and one or more middle layer comprising treated latex paint and one or more water-insoluble polymer component, e.g., a polyolefin, immiscible with the treated latex paint.

In an embodiment, monolayer polymeric films and/or articles thereof, e.g., bags, are from about 0.5 to about 8 mils in thickness, or from about 0.8 to about 4 mils in thickness. The monolayer comprising the treated latex paint will necessarily account for 100 percent of the thickness. In an embodiment, a monolayer comprises polyethylene homo- and/or co-polymers, or a derivative, mixture or blend thereof, that are able to be processed with melt flow index (MFI) ranging in value from about half (0.5) to about twenty (20) MFI, or from about one (1) to about five (5) MFI. In an embodiment, treated latex paint (e.g., a latex dry blend or a latex concentrate) is fed directly to the one or more water-insoluble polymer component, e.g., polyethylene homo- and/or co-polymers, of the monolayer.

In another embodiment, there are provided blown extruded, monolayer polymeric films or articles thereof, comprising: a) about 42 to about 99 wt. % of polyethylene homo- and/or co-polymer, or a derivative, mixture, and/or blend thereof; b) about 0 to about 20 wt. % of titanium dioxide, carbon black, or a colorant; c) about 0.01 to about 10 wt. %, of one or more additive(s) (e.g., antiblocks, slips, antifogs, coupling agents, compatibilizers, antioxidants, odor neutralizing compounds, odor masking compounds, etc.); and d) about 1 to about 40 wt. % of latex concentrate, the latex concentrate comprised of about 30 to about 95 wt. % polyethylene homo- and/or co-polymer, or a derivative, mixture, or blend thereof, and about 5 to about 70 wt. % treated latex paint. Such plastic articles may be used, for example, in consumer packaging applications. In an embodiment, monolayer polymeric films or articles thereof comprise in a) about 42 to about 99.9 wt. % or about 42 to about 99.94 wt. % of polyethylene homo- and/or co-polymer, or a derivative, mixture, and/or blend thereof.

In yet another embodiment, there are provided monolayer polymeric films and articles thereof comprising one or more water-insoluble polymer component (i.e., immiscible with treated latex paint), that is polyethylene homo- and/or co-polymer such as low density polyethylene (LDPE), high density polyethylene (HDPE), linear low density polyethylene (LLDPE; refers to copolymers of ethylene with one or more comonomers selected, for example, from C4 to C10 alpha-olefins such as butene-1 or, octane), and/or a copolymer of ethylene and another hydrocarbon such as, for example, ethylene vinyl acetate (EVA), ethylene acrylic acid (EAA), and/or a blend thereof.

In an embodiment, there are provided blown extruded multilayer area-measured plastic articles of at least three layers comprising: 1) at least one outer layer (e.g., facing earthward) comprising: a) about 40 to about 100 wt. % polyethylene homo- and/or co-polymer, or a derivative, mixture, and/or blend thereof; b) about 0 to about 20 wt. % colorant (e.g., organic pigment, inorganic pigment, and/or dye) and/or additive(s) (e.g., an antiblock agent, a slip agent, an antifog agent, an antioxidant, a light stabilizer, and/or a UV absorber); and c) about 0 to about 40 wt. % of treated latex paint; 2) at least one outer layer (e.g., facing skyward) comprising: a) about 35 to about 100 wt. % polyethylene homo- and/or co-polymer, or a derivative, mixture, and/or blend thereof; b) about 0 to about 25 wt. % colorant (e.g., organic pigment, inorganic pigment, and/or dye) and/or additive(s) (e.g., an antiblock agent, a slip agent, an antifog agent, an antioxidant, a light stabilizer, and/or a UV absorber); and c) about 0 to about 40 wt. % of treated latex paint; and 3) a middle layer assembly comprising: a) about 50 to about 100 wt. % polyethylene homo- and/or co-polymer, or a derivative, mixture, and/or blend thereof; b) about 0 to about 40 wt. % treated latex paint; and c) about 0 to about 10 wt. % colorant (e.g., organic pigment, inorganic pigment, and/or dye) and/or additive(s) (e.g., a compatibilizer agent, a coupling agent, a desiccant agent, an antiblock agent, a slip agent, an antifog agent, an antioxidant agent, a light stabilizer, and/or a UV absorber). Such plastic articles may be used, for example, in crop production.

In an embodiment, methods described herein provide smooth polymeric films and/or articles thereof, e.g., films, sheets and bags, which optionally can be followed by a post-embossed process to provide a textured surface. In other embodiments, smooth films or articles can optionally be surface treated followed by a post-lamination or a vacuum metallized process to provide polymeric films and articles thereof, e.g., films, sheets and bags, for specific high end applications.

Articles formed according to methods described herein are also provided. Such articles may have a wide range of application, including without limitation consumer applications (such as garbage bags), industrial packaging applications (such as shrink films, plastic liners and cement bags), and agricultural applications (such as in crop production, packaging bags for soil and compost). In an embodiment, a blown extrusion process is used to provide monolayer, area-measured plastic articles. In another embodiment, a blown extrusion process is used to provide multilayer, area-measured plastic articles having at least three layers. In an embodiment, a blown extrusion process is used to provide monolayer and/or multilayer area-measured plastic articles comprising prime, virgin, non-prime, recycled, and/or post-recycled polymers. Recycled and/or post-recycled polymers may be, for example, printed, non-printed, pigmented and/or non-pigmented polymers comprising polyethylene homo- and/or co-polymers, or a derivative, mixture, or blend thereof.

In an embodiment, there are provided methods for compounding and/or an equivalent related process that are safe, practical, and/or suitable for applications involving recycling of waste latex paint for the plastics industry.

In another embodiment, there are provided methods for recycling latex paint in the manufacture of polymeric films and articles thereof for direct use by consumers. In some embodiments, these methods include addition of odor neutralizing and/or odor masking compounds. Such polymeric films and articles thereof for use directly by consumers include, without limitation, garbage bags, shrink films, and merchandise bags. In some embodiments, such polymeric films are thin films.

In some embodiments, there are provided methods for treating waste latex paint to form treated latex paint suitable for use in the preparation of polymeric films and articles thereof. In an embodiment, treated latex paint is suitable for use in thin film applications. Such methods may include one or more of the following steps: 1) a liquid-solid separation process, for example to reduce initial moisture content to at least about 25 to about 30 wt. %, about 15 to about 25 wt. %, or less than about 15 wt. %; 2) a drying process to drop volatiles and/or moisture content to about 0.1 wt. % to about 0.50 wt. %, or to about 0.50 wt. % or less; 3) a treatment process to remove ethylene glycol and/or VOCs; and 4) a process of removing and/or downsizing particles or contaminants greater than about 45 microns in size by, e.g., filtration and/or milling.

In an embodiment, there are provided methods for reducing moisture content in waste latex paint; for removing ethylene glycol and/or VOCs; and/or for controlling particle size distribution and/or top particle size in waste latex paint, to ensure compatibility of treated latex paint with continuous film-making processes such as blown film extrusion or cast film extrusion for forming a polymeric film or sheet structure. In some embodiments, there are provided methods for treating waste latex paint to form treated latex paint suitable for use in the preparation of polymeric films and articles thereof using a continuous film-making process such as blown film extrusion or cast film extrusion. In some embodiments, the polymeric films and/or articles have a thickness of about 4 mils or less.

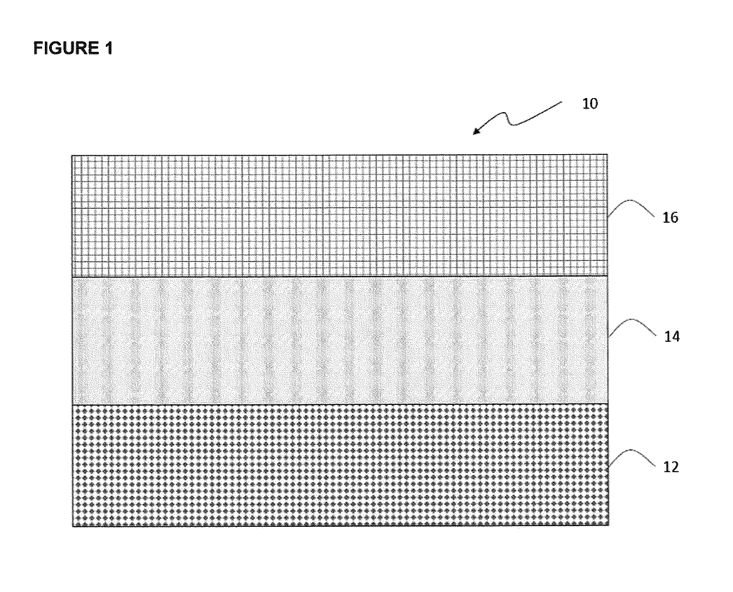

Referring now to the Figures, which are provided only to illustrate and not to limit the invention, in FIG. 1 there is shown a schematic cross-sectional view of a multilayer thin film according to one embodiment. The exemplary embodiment shown in FIG. 1 includes a multilayer film 10 including a lower, earthward layer 12, an upper, skyward layer 16, and a middle layer 14. It should be noted that FIG. 1 is not drawn to scale and that each layer 12, 14, 16 may have a distinct thickness. FIG. 1 has thus been greatly simplified for ease of illustration.

In an embodiment, the multilayer film 10 includes polymeric film comprising: 1) at least one outer earthward layer 12 comprising about 40 to about 100 wt. % polyethylene homo- and co-polymer; about 0 to about 20 wt. % of colorant and/or additive; and about 0 to about 40 wt. % of treated latex paint; 2) at least one outer skyward layer 16 comprising about 35 to about 100 wt. % polyethylene homo- and co-polymer; about 0 to about 25 wt. % of colorant and/or additive; and about 0 to about 40 wt. % of treated latex paint; and c) the middle layer 14 comprising about 50 to about 100 wt. % polyethylene homo- and co-polymer; about 0 to about 40 wt. % of treated latex paint; and about 0 to about 10 wt. % of colorant and/or additive.

In an embodiment, at least one outer layer 12, 16 of a multilayered film 10 comprises a water-insoluble polymer, such as a polyethylene homo- and co-polymer like low density polyethylene (LDPE), high density polyethylene (HDPE), linear low density polyethylene (LLDPE; note this refers to copolymers of ethylene with one or more comonomers selected, for example, from a C4 to C10 alpha-olefin such as butene-1 or octane), and/or a copolymer of ethylene and another hydrocarbon such as ethylene vinyl acetate (EVA), ethylene acrylic acid (EAA), or a blend thereof.

In another embodiment, the skyward outer layer 16 and/or the earthward outer layer 12 comprises from about 1 to about 40 wt. % of a treated latex paint. In an embodiment, the skyward outer layer 16 and/or the earthward outer layer 12 comprises from about 1 to about 20 wt. % of a treated latex paint.

In another embodiment, multilayer film 10 comprises middle layer 14 free of treated latex paint, the middle layer 14 comprising: a) a polyethylene homo- and co-polymer such as low density polyethylene (LDPE), high density polyethylene (HDPE), linear low density polyethylene (LLDPE; refers to copolymers of ethylene with one or more comonomers selected, for example, from C4 to C10 alpha-olefins such as butene-1 or octane), and/or a copolymer of ethylene and another hydrocarbon such as, for example, ethylene vinyl acetate (EVA), ethylene acrylic acid (EAA), or a blend thereof; b) a polyamide resin such as a polyamide, e.g., nylon 6, and/or a polyamide copolymer, e.g., nylon 6/66; and/or c) an ethylene vinyl alcohol copolymer comprising, for example, from about 25 to about 50 mol percent ethylene.

In some embodiments, middle layer 14 comprises a plurality of polymeric film sub-layers 14₁, 14₂, 14₃, 14₄, . . . 14ₙ. Such sub-layers may be used, in some embodiments, to prevent delamination of the multilayer film 10.

In yet another embodiment, multilayer film 10 comprises an outer layer 12, 16 further comprising additive(s). Such additives may, for example, provide a desired property of a multi-area plastic article. Non-limiting examples of such additives include colorants, ultraviolet (UV) absorbers, inhibitors and/or light stabilizers; organic and/or inorganic anti-blocks (based, e.g., on amorphous or crystalline silicates, Kaolin or amides); slip agents such as primary amides, secondary amides, oleamide, stearamide, and derivatives thereof; lubricants such as polyolefine waxes, PE waxes and PP waxes and metal stearates; anti-oxidants; anti-fog additives, such as glycerol esters of fatty acids, alkoxylated alkyl phenols, and polyalkoxylated fatty acid esters; compatibilizers such as ethylene copolymers, and sodium ionomers; coupling agents such as maleic anhydrides, anhydride modified polyethylene, a zirconate, a titanate, an aluminates, or a silane; odor neutralizers and/or odor masking agents such as a zinc salt of ricinoleic acid, activated carbon, magnesium oxide, amorphous sodium potassium aluminum silicate, magnesium sulfate, a plant extract, cyclohexaamylose, an ester, a fragrance, and/or a desiccant such as calcium oxide, bentonite clay, a silica gel, or zeolite. It will be appreciated by the skilled artisan that other additives may be used and will be chosen based on the desired properties and characteristics of a film or article thereof. It will also be appreciated that additives may be added at many different steps during production of the polymeric films and articles described herein, as will be determined by the skilled artisan.

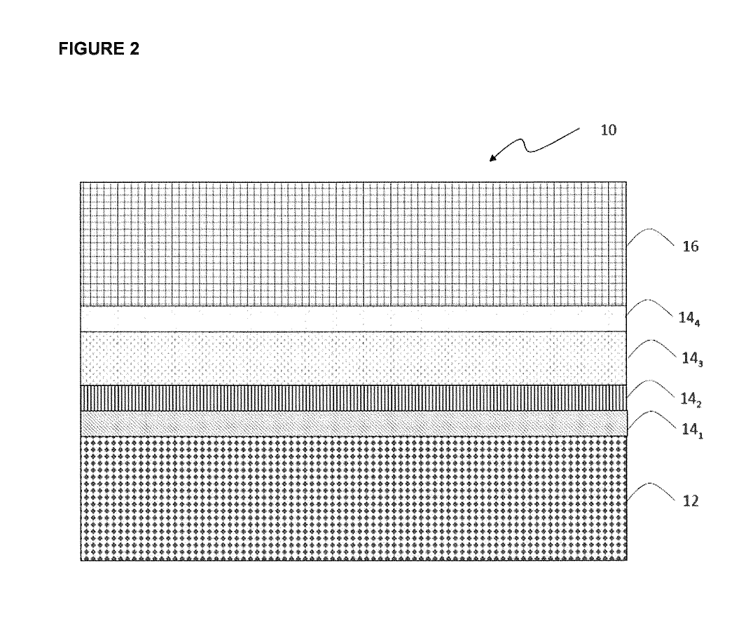

Referring now to FIG. 2, in FIG. 2 there is shown a schematic cross-sectional view of a multilayer film having sub-layers 14₁, 14₂, 14₃, 14₄, . . . 14ₙ in its middle layer, in accordance with one embodiment. FIG. 2 shows a treated-latex-paint-free middle layer 14 comprising sub-layers 14₁, 14₂, 14₃, 14₄ . . . 14ₙ. In some embodiments, three (3) to five (5) sub-layers are included. It should be noted that FIG. 2 is not drawn to scale and that each layer 12, 14, 16 or sub-layer 12ₙ (not depicted), 14₁, 14₂, 14₃, 14₄, . . . 14ₙ, 16ₙ (not depicted) may have a distinct thickness. It is further noted that, in some embodiments, separating the middle layer 14 into sub-layers 14₁, 14₂, 14₃, 14₄, . . . 14ₙ may help to prevent delamination in cases where the materials of the treated-latex-paint-free layer and the outer layer 12, 16 do not bond easily together. In some embodiments, to prevent delamination, a treated-latex-paint-free middle layer 14 is sandwiched between small layers (referred to as “tie layers”) to form a three sub-layered composite (not depicted). A tie layer may comprise, for example, a cyclic anhydride-modified polyolefin resin. In an embodiment, a three sub-layered composite is further sandwiched between two sub-layers of low density polyethylene (LDPE) and/or high density polyethylene (HDPE) to form a five layer composite middle layer 14, where there is no direct contact between the tie layers and the treated latex paint.

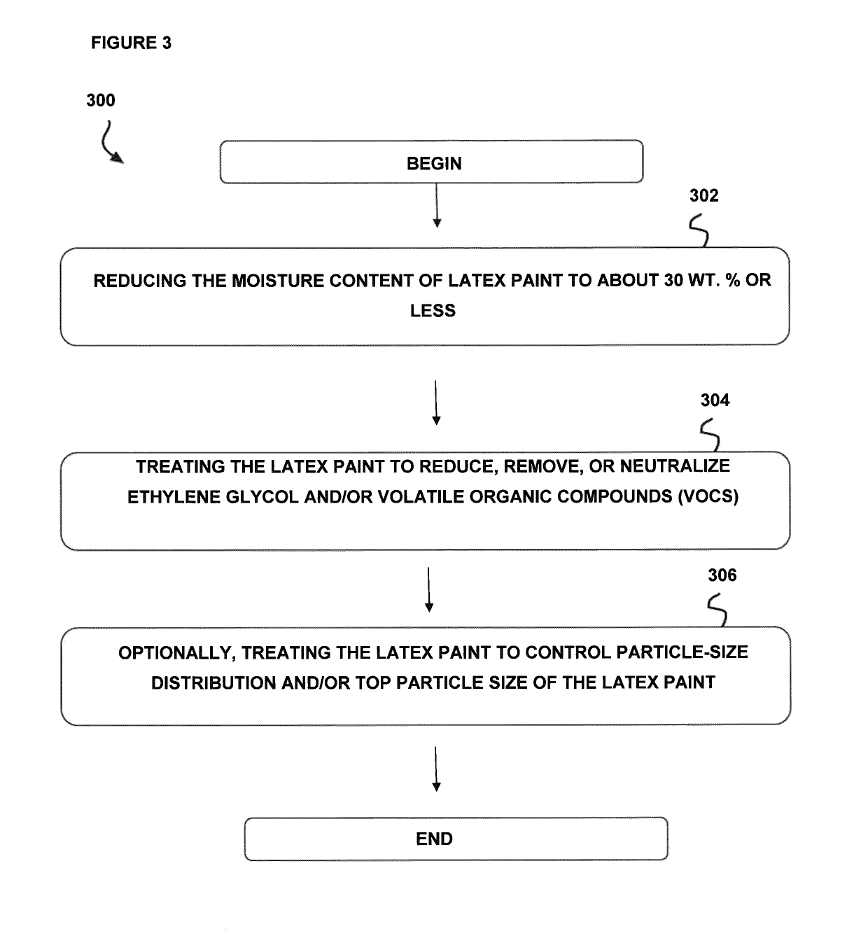

Referring now to FIG. 3, in FIG. 3 there is shown a block diagram of a method 300 for preparing treated latex paint, in order to allow recycling of waste latex paint in a polymeric film according to methods provided herein, the method 300 being implemented in accordance with non-limiting embodiments of the present technology.

Step 302—Reducing the Moisture Content of the Latex Paint to about 30 wt. % or Less.

The method 300 begins at step 302, where moisture content of the latex paint is reduced to about 30 wt. % or less. In some embodiments, moisture content of the latex paint is reduced to about 25 wt. % or less, to about 15 wt. % or less, or to about 15 wt. % to about 25 wt. %. In some embodiments, moisture content of the latex paint is reduced by a process of liquid-solid separation, e.g., using centrifugation, rotary pressure filtration, auto pressing, vacuum belt filtration, vacuum drying, pressure plate filtration, or other similar methods known in the art. In some embodiments, moisture content of the latex paint is reduced by drying. In some embodiments, moisture content of the latex paint is reduced by both liquid-solid separation and drying.

In some embodiments, step 302 is preceded by a step (not illustrated) of collecting and/or sorting the latex paint, e.g., waste latex paint. For example, latex paint (e.g., waste latex paint) is optionally sorted to separate paint in liquid form (typically a thick viscous liquid, referred to herein as “liquid paint”) from dried paint (including partially pre-dried paste, referred to herein as “wet paint”). Paint may also be in a pre-dried, particulate or powder form. Waste latex paint may also be identified chemically using information provided, such as information received from a waste treatment facility, a retailer, or a consumer, or information obtained using a chemical analytical method to identify the main components of the waste latex paint. Such analytical methods are well-known in the art.

The latex paint to be recycled or treated is not particularly limited. For example, latex paint may be flat latex paint, satin latex paint, gloss latex paint, semi-gloss latex paint, high-gloss latex paint, or a mixture thereof. Latex paint may be pigmented. Latex paint may comprise, for example, acrylic, vinyl, and/or rubber polymer. Non-limiting examples of latex paint polymers include acrylates, vinyl acrylates, vinyl acetates, styrene acrylates, polyesters, alkyd polyesters, epoxides, and neoprene. It should be understood that latex paint to be recycled or treated may include one or more type of latex paint.

In some embodiments, in step 302 the liquid paint is subjected to an initial liquid-solid separation process to reduce overall moisture content, e.g., to between about 15 to about 30 wt. %, to between about 15 to about 25 wt. %, to about 30 wt % or less, to about 25 wt % or less, or to about 15 wt. % or less. Many such processes are known in the art, including without limitation centrifugation, rotary pressure filtration, auto pressing, vacuum belt filtration, vacuum drying, and pressure plate filtration systems.

In some embodiments, moisture content of the latex paint is reduced in step 302 by drying, e.g., by heating at a temperature in the range of about 60° C. to about 600° C., about 100° C. to about 600° C., or in the range of about 200° C. to about 500° C., under regular ambient pressure conditions.

Step 304—Treating the Latex Paint to Reduce, Remove, or Neutralize Ethylene Glycol and/or Volatile Organic Compounds (VOCs).

Latex paints often include undesirable chemicals and volatiles that it is advantageous to remove for processing, environmental and/or safety reasons. For example, latex paint typically includes antifreeze compounds, such as ethylene glycol, that need to be contained and/or neutralized before paint is incorporated into films and articles thereof. Such chemicals may be toxic, and/or may adversely affect the physical properties of films and articles thereof. For example, ethylene glycols are high boiling point alcohols that will produce vapors at regular film processing temperatures, causing bubble formation and surface roughness of films and articles thereof.

Continuing now with the method 300, the latex paint is treated to reduce, remove, or neutralize ethylene glycol and/or volatile organic compounds (VOCs). In some embodiments, liquid paint, e.g., liquid paint obtained in step 302, is treated in step 304. In some embodiments, wet paint is treated in step 304. In some embodiments, both liquid and wet paint are treated in step 304. Liquid and wet paint may be treated together or separately. It will be understood by the skilled artisan that chemical treatment is generally conducted in a suitable vessel, e.g., a reactor or mixer such as a batch reactor, a hot/cold jacketed high/low shear intensity mixer, a semi-continuous stirred tank reactor, or a plug flow tubular reactor.

In some embodiments, chemical treatment is used to reduce, remove, or neutralize ethylene glycol. In some embodiments, an esterification reaction is carried out between ethylene glycol and a carboxylic acid, producing mono- and di-esters. In an embodiment, ethylene glycol is reacted with stearic acid in the presence of a strong catalyst (e.g., Amberlyst™ 36) to produce glycol stearate and glycol distearate. It will be understood by the skilled artisan that the molar ratio of acid to glycol determines the relative yields and can be varied according to desired yields. The stoichiometry of this reaction is shown in Scheme 1.

(CH₂OH)₂+RCOOH→RCOOCH₂—CH₂OH+H₂O

(CH₂OH)₂+2RCOOH→RCOOCH₂—CH₂OOCR+H₂O

Scheme 1. Ethylene Glycol is Reacted with Stearic Acid to Produce Glycol Stearate and Glycol Distearate. The Molar Ratio of Acid to Glycol Determines the Relative Yields.

In some embodiments, supplemental additives and/or catalysts are added to the latex paint in the reaction vessel at this stage. It will be understood by the skilled artisan that the desired weight percentage of each component can be controlled using, for example, gain in weight or loss in weight automated feeding systems. For example, the mix may first undergo a cold mixing process for adequate time to ensure sufficient distribution of the mix at an appropriate mixing speed with proper mixing configurations, as will be determined by the skilled artisan using common general knowledge in the art. The temperature of the mixing vessel is set to create sufficient heating conditions to start the esterification reaction. In an embodiment, the temperature of the mixing vessel is from about 340 K to about 370 K. Mixing speed and duration are adjusted as required to provide proper thermal distribution and adequate dispersion of the viscous mix. The skilled artisan appreciates that other possible temperature settings and reaction kinetics may be used depending on the catalyst, reactants, molar ratios, and end product desired, and will adjust reaction conditions accordingly.

The skilled artisan will also appreciate that supplemental additives (e.g., colorants, odor neutralizers, etc.) may be added at many different steps of the methods described herein. The step at which an additive or colorant may be added is not meant to be limited.

In some embodiments, other chemical reactions are used to reduce, remove, or neutralize ethylene glycol. It should be appreciated that ethylene glycol can be reacted similarly with other organic acids. In some embodiments, an oxidation reaction between ethylene glycol and an inorganic acid, such as nitric acid, is performed to produce glyoxal, which can further react with other derivatives to form 1,3-Dioxolane, 1,4-Dioxane, etc. In some embodiments, ethylene glycol is reacted with stearic acid, acetic acid, adipic acid, capric acid, lauric acid, myristic acid, palmitic acid, propanoic acid, and/or nitric acid.

It should be understood that ethylene glycol in the latex paint may be a derivative, analog, and/or byproduct of ethylene glycol, such as those that are commonly used as antifreeze. In some embodiments, the ethylene glycol is diethylene glycol, triethylene glycol, tetraethylene glycol, propylene glycol, or a mixture thereof.

In some embodiments, the amount of ethylene glycol in the treated latex paint is reduced sufficiently to meet process, environmental and/or safety regulations. In some embodiments, after treatment the treated latex paint comprises no more than 1 wt. % of ethylene glycol. In some embodiments, after treatment the treated latex paint comprises from about 0.1 to about 0.3 wt. % of ethylene glycol. In some embodiments, after treatment the treated latex paint comprises no more than trace amounts of ethylene glycol, i.e., no more than a very small amount that is able to be detected using known analytical techniques but not able to be quantified.

In some embodiments, waste latex paint is treated by heating at high temperature to reduce, remove, or neutralize volatile organic compounds (VOCs). For example, heat sensitive solid and/or liquid contaminants in the paint may be transformed into the gaseous state by heating at high temperature. In some embodiments, latex paint is subjected to temperatures above about 100° C., temperatures in the range of about 200° C. to about 500° C., or temperatures of about 500° C. or higher at atmospheric pressure (i.e., under regular ambient pressure conditions). In some embodiments, gases produced by heating paint are exposed to an air neutralizer system(s), which removes or breaks down VOCs, e.g., thermally, chemically, or with radiation. For example, many VOCs found in latex paint are hydrocarbon based and can be destroyed by thermal combustion, typically producing carbon dioxide (CO₂) and water (H₂O). It should be understood that liquid paint, wet paint, or both may be treated by heating at high temperatures. It should be further understood that heating at high temperatures may be used in place of chemical treatment to reduce, remove, or neutralize ethylene glycol, or in addition to such chemical treatment.

In some embodiments, step 304 is preceded and/or followed by a step (not illustrated) of drying the latex paint to reduce further the moisture content and the content of VOCs, if desired. In some embodiments, moisture content of the latex paint is further reduced to about 0.1 wt. % to about 0.5 wt. %, or to about 0.5 wt. % or less. %. In an embodiment, moisture content of the latex paint is reduced to about 0.10 wt. % to about 0.50 wt. %. It will be understood by the skilled artisan that this drying step may be carried out using known methods, such as by a batch, a continuous, or a semi-continuous system, such as by using a flash dryer, a spray dryer, a vacuum dryer, a conduction dryer, or a fluidized bed dryer. In some embodiments, the latex paint is dried at a temperature in the range of about 60° C. to about 600° C. or about 100° C. to about 600° C., under regular ambient pressure conditions. In some embodiments, the latex paint is dried at a temperature in the range of about 200° C. to about 500° C. under regular ambient pressure conditions. The appropriate temperature and drying residence time will be determined by the skilled artisan based on characteristics and properties of the latex paint utilized, pressure conditions, and other considerations as known in the art.

Step 306—Optionally, Treating the Latex Paint to Control Particle-Size Distribution and/or Top Particle Size of the Latex Paint.

Continuing now with the method 300, the latex paint is treated to control particle-size distribution and/or top particle size. In some embodiments, particles or contaminants greater than about 45 microns in size, or greater than about 25 microns in size, or greater than about 25 to about 45 microns in size, are removed. In some embodiments, particles or contaminants greater than about 45 microns in size, or greater than about 25 microns in size, or greater than about 25 to about 45 microns in size, are downsized.

In some embodiments, particles or contaminants greater than the desired size are removed by filtration, e.g., by passing the latex paint through a single screen, through multiple screens, or through a series of screens. Many fine screen filtration systems are known in the art and may be used in methods described herein. In some embodiments, milling is used to downsize oversized particles or contaminants. For example, oversized particle or contaminants may be milled to reduce their size to about 45 microns or less, e.g., to about 2 to about 45 microns in size. In some embodiments, about 45 microns is the top particle size in the treated latex paint. It should also be understood that the latex paint being treated may be in liquid, wet, or dried form, e.g., may be liquid paint or wet paint, or may be dried paint in powdered form. In some embodiments, latex paint in dried, powdered form is filtered or screened to control particle-size distribution and/or top particle size. In some embodiments, filtration may take place during compounding or an equivalent process. In some embodiments, a molten polymer containing latex paint solids is passed through a screen filtration system to remove particles of greater than about 45 microns in size.

In some embodiments, oversized particles or contaminants are milled to reduce their size to about 45 microns or less, and then added back to the latex paint.

It should be understood that steps 302, 304, and 306 steps may be carried out in any order, depending on several factors such as the condition of the starting latex paint, the desired properties of the end product, and so on. For example, step 306 may be omitted if the particle size is already 45 microns or lower. The need for liquid-solid separation or drying will necessarily depend on the state of the starting latex paint. Similarly, levels of ethylene glycol and VOCs in paint will vary. Further, steps 302, 304, and 306 may be performed in conjunction with other processes. For example, the latex paint may be filtered to remove oversized particles during compounding or an equivalent process.

In some embodiments, there are provided methods of recycling latex paint in a polymeric film, comprising the steps 302, 304, 306 depicted schematically in FIG. 3, and as described above.

### Examples

The present technology is more readily understood by referring to the following examples, which are provided to illustrate the technology and are not to be construed as limiting the scope thereof in any manner.

Unless defined otherwise or the context clearly dictates otherwise, technical and scientific terms used herein have the same meaning as commonly understood by one of ordinary skill in the art to which this invention belongs. It should be understood that any methods and materials similar or equivalent to those described herein can be used in the practice or testing of the invention. The skilled artisan having the benefit of the present disclosure will be able to carry out different variations, modifications and adaptations, without deviating from the fundamental technology of the present disclosure.

### Example 1. Preparation of a Latex Concentrate, and Use Thereof in Manufacturing a Mono-Layered Film

Approximately 35 kg of compounded latex concentrate was prepared as follows.

Two pails of waste latex paint were collected from a recycling facility in Quebec. The waste latex paint contained about 44 wt. % water, 16 wt. % acrylic latex polymer, 30 wt. % calcium carbonate, 5 wt. % titanium dioxide, 4 wt. % ethylene glycol, and 1 wt. % kaolin. 15.6 kg of the collected waste latex paint was used to prepare about 35 kg of compounded latex concentrate.

The waste latex paint was weighed, and mixed with shredded pigmented recycled low density polyethylene (referred to hereafter as “repro LDPE”), shredded pigmented recycled linear low density polyethylene butene (referred to hereafter as “repro LLDPE BUTENE”), and shredded pigmented recycled high density polyethylene (referred to hereafter as “repro HDPE”) at 37.33, 20.00, 20.00 and 22.67 weight percent, respectively. Each component was fed to a hot/cold jacketed mixing vessel through a separate port. Each component also had a separate weighing system. All components were initially mixed together as a cold mix for a short period of time, followed by heating the vessel and maintaining temperature at around 85° C. for about 40 minutes at a reduced rpm, to maximize the drying process of the wet latex paint, while preventing the recycled polymer blend from changing to molten phase. After drying, the overall composition was about 25, 23.93, 23.93 and 27.14 weight percent of dried latex paint, repro LDPE, repro LLDPE BUTENE and repro HDPE polymer, respectively.

The drying process was followed by an esterification reaction initiated by the addition of stearic acid and Amberlyst™ 36 catalyst at 3.0 and 1.5 weight percent, respectively. Both components were mixed properly with the dried latex paint and repro polymer mix which contained around 1 weight percent of ethylene glycol at a high rpm in a densifier to ensure proper distribution of reactant and catalyst in the solid state blend. The vessel temperature was maintained at around 85-90° C. for about 50 minutes in order to optimize reaction kinetics. Upon completion of chemical treatment, the vessel temperature was increased to about 102-105° C. for about 3 to 5 minutes to melt the polymer blend and permit a partial encapsulation of the treated latex paint into the recycled polymer matrix. This process was then followed by a quick cooling process by spraying a small amount of cold water into the polymer mix to drop the overall temperature of the polymer mix to about 60-70° C. The discharge port of the mixing vessel (densifier) was then turned to an open position to discharge the treated latex paint.

The treated latex paint was then transferred to a double stage vented single screw extruder to complete the compounding process. The treated latex paint was fed directly through the main feed hopper of a 4½″ single extruder with 30:1 L/D ratio with the temperature profile shown in Table 1.

TABLE 1
Temperature profile used in main feed hopper during compounding.

| Zone 1 | Zone 2 | Zone 3 | Zone 4 | Zone 5 | Zone 6 | Zone 7 | Adap. | Screen | Die |
|---|---|---|---|---|---|---|---|---|---|
| 360° F. | 380° F. | 405° F. | 385° F. | 370° F. | 395° F. | 420° F. | 420° F. | 420° F. | 420° F. |

The screw speed was set at 50 rpm, 80% motor load and the pressure head ranged between 2400 to 2600 psi. About six wire-mesh screen packs were used for the test to filter out oversized particles. Each pack was composed of 30/60/100/200/325/200/100/60/30 screens. An underwater pelletizing unit was used for the test and the pelletizer was set at 750 rpm. The final compounded latex concentrate had an elliptical pigmented pellet form with a bulk density of about 0.61 g/cm³.

A mono-layer blown film extrusion line with a single screw size of 3½″, 24:1 L/D ratio and a 14″ die was used to produce a garbage bag film. The monolayer film was composed of 91 wt. % of the compounded latex concentrate, 3 wt. % maleic anhydride concentrate, 3 wt. % carbon black concentrate, 2 wt. % slip/antiblock concentrate and 1 wt. % polymer processing aid concentrate. The processing parameters were set at 90 rpm screw speed with 106 amps motor load, 148 ft/min top nip speed, 38.8% cooling air ring and 300 lbs/hr throughput to produce a thin polymeric film with a gauge of 0.90 mil. The die pressure ranged between 3000-3200 psi and the melt temperature was about 235° C. The temperature profile in Table 2 was used to make the film.

TABLE 2
Temperature profile used to make mono-layer film.

| Zone 1 | Zone 2 | Zone 3 | Zone 4 | Zone 5 | Screen | Adap. | Nick | Die 1 | Die 2 |
|---|---|---|---|---|---|---|---|---|---|
| 180° C. | 205° C. | 200° C. | 190° C. | 190° C. | 205° C. | 220° C. | 205° C. | 210° C. | 215° C. |

### Example 2. Preparation of a Latex Concentrate, and Use Thereof in Manufacturing a Three-Layered Film

Approximately 70 kg of compounded latex concentrate was prepared.

The remaining waste latex paint collected in Example 1 was used. The waste latex paint contained about 44 wt. % water, 16 wt. % acrylic latex polymer, 30 wt. % calcium carbonate, 5 wt. % titanium dioxide, 4 wt. % ethylene glycol, and 1 wt. % kaolin. About 44 kg of the waste latex paint was used to prepare about 70 kg of compounded latex concentrate.

First, the 44 kg of wet waste latex paint was sent to a small super flash drying unit with the capability of evaporating water at about 200 kg/hr. The waste latex paint was exposed to about 500° C. inlet hot air temperature and about 18 m³/min outlet air volume for about fifteen minutes to ensure sufficient release of water vapor and other volatile organic compounds (VOCs). The final weight of dried waste latex paint was about 24.5 kg. The dried waste latex paint was weighed, and mixed with pulverized HMW-HDPE, pulverized VLLDPE OCTENE, maleic anhydride concentrate, and titanium dioxide pigment at 35, 36.56, 16.25, 8.19 and 4.00 weight percent, respectively. Each component was fed to a 200 liter hot/cold jacketed high intensity Henschel mixing vessel through a separate port. Each component had a separate weighing system. All components were mixed as “cold mix” at the proper rpm setting for 8 minutes to ensure good distributive mix. The discharge port of the mixing vessel was then turned to an open position to discharge the premix/dry blend.

The premix/dry blend was then transferred to a double stage vented single screw extruder to complete the compounding process. The premix/dry blend was fed directly through the main feed hopper of 4½″ single extruder with 30:1 L/D ratio following the temperature profile shown in Table 3.

TABLE 3
Temperature profile.

| Zone 1 | Zone 2 | Zone 3 | Zone 4 | Zone 5 | Zone 6 | Zone 7 | Adap. | Screen | Die |
|---|---|---|---|---|---|---|---|---|---|
| 390° F. | 395° F. | 410° F. | 385° F. | 370° F. | 405° F. | 420° F. | 420° F. | 420° F. | 420° F. |

The screw speed was set at 40 rpm, 90% motor load and the pressure head ranged between 3200 to 3500 psi. About thirteen wire-mesh screen packs were used for the test to filter out the oversized particles. Each pack was composed of 30/60/100/200/325/200/100/60/30 screens. An underwater pelletizing unit was used for the test and the pelletizer was set at 600 rpm. The final latex concentrate had spherical white pigmented pellet form with a bulk density of about 0.71 g/cm³.

A three-layer coex blown film extrusion line was used to produce a vegetation white black film structure. The three ply A/B/C film was made by coextruding the middle layer A (A composed of 100% latex concentrate), the earthward layer B (B composed of 80% LLDPE BUTENE, 17% UV black concentrate and 3% slip/antiblock concentrate), and the skyward layer C (C composed of 74.8% LLDPE BUTENE, 20% UV white concentrate and 3% slip/antiblock concentrate). The coextruded film was about 1.25 mil thick comprised of a 0.75 mil middle layer A, a 0.19 mil earthward layer B, and a 0.31 mil skyward layer C. The throughput of extruders A, B and C was maintained at around 299.3, 76.0 and 124.7 lbs/hr, respectively. The size of the extruders A, B and C was 80 mm, 70 mm, and 70 mm in diameter, respectively, with L/D 28:1. The film was produced at 34.72″ wide using a 10″ circular die and a total film density of 1.012 g/cm³. The flow of material was constantly controlled and adjusted in such a way, that the final A/B/C ply layer ratio of the final plastic article was about 60, about 15, and about 25, respectively.

Those of ordinary skill in the art will realize that the description of the films and processes for making such films are illustrative only and are not intended to be in any way limiting. Other embodiments will readily suggest themselves to such persons with ordinary skill in the art having the benefit of the present disclosure. Furthermore, the disclosed films and processes may be customized to offer valuable solutions to other potential needs and problems.

In the interest of clarity, not all of the routine features of the implementations of the present processes and film products are shown and described. It will, of course, be appreciated that in the development of any such actual implementation of the products and processes, numerous implementation-specific decisions may need to be made in order to achieve the developer's specific goals, such as compliance with application-, system-, regulatory- and business-related constraints, and that these specific goals will vary from one implementation to another and from one developer to another.

Although the present disclosure has been described hereinabove by way of non-restrictive, illustrative embodiments thereof, these embodiments may be modified at will within the scope of the appended claims without departing from the spirit and nature of the present disclosure. The scope of the present technology is therefore intended to be limited solely by the scope of the appended claims.

All documents and references cited herein are hereby incorporated by reference in their entirety.

What is claimed is:

1. A polymeric film comprising treated latex paint and one or more water-insoluble polymer component immiscible with the treated latex paint, wherein the treated latex paint comprises at least one latex paint polymer.

2. The polymeric film of claim 1, wherein the film has a thickness of less than about 4 mils.

3. The polymeric film of claim 1, wherein the film comprises no more than trace amounts of ethylene glycol.

4. The polymeric film of claim 1, wherein the film is prepared using a continuous film-making process.

5. The polymeric film of claim 1, wherein the one or more water-insoluble polymer component is selected from the group consisting of polyolefins, and combinations thereof.

6. The polymeric film of claim 5, wherein the polyolefin is low density polyethylene (LDPE), low density polyethylene butene (LLDPE BUTENE), linear low density polyethylene (LLDPE), very low density polyethylene (VLLDPE), very low density polyethylene octene (VLLDPE OCTENE), high density polyethylene (HDPE), a copolymer of ethylene and another hydrocarbon, or a derivative, mixture, or combination thereof.

7. The polymeric film of claim 1, wherein the one or more water-insoluble polymer component comprises a prime virgin polymer, a non-prime polymer, an off-spec polymer, a recycled polymer, a post-recycled polymer, or another polymer suitable for production of thin films and/or articles thereof via a continuous film-making process or an extrusion method.

8. (canceled)

9. The polymeric film of claim 7, wherein the recycled or post-recycled polymer is selected from the group consisting of printed, non-printed, pigmented, and non-pigmented recycled polymers.

10. The polymeric film of claim 1, wherein said treated latex paint comprises flat latex paint, satin latex paint, gloss latex paint, semi-gloss latex paint, high-gloss latex paint, or a mixture thereof.

11. The polymeric film of claim 10, wherein said latex paint is pigmented.

12. The polymeric film of claim 1, wherein said latex paint polymer comprises one or more polymers selected from the group consisting of acrylate polymers, vinyl acrylate polymers, vinyl acetate polymers, styrene acrylate polymers, polyurethanes, epoxides, polyesters, neoprene, and alkyd polyesters, and wherein said treated latex paint has been prepared by treating latex paint comprising one or more of the following: water, latex polymer binder, filler, color, and ethylene glycol.

13. (canceled)

14. The polymeric film of claim 1, wherein said treated latex paint was prepared in the form of a latex concentrate or a latex dry blend prior to formation of the polymeric film, wherein the latex dry blend comprises from about 1 to about 100 wt. % of treated latex paint.

15. The polymeric film of claim 14, wherein the polymeric film comprises from about 1 to about 100 wt. % of the latex concentrate, or from about 1 to about 99 wt. % of the latex concentrate, and/or wherein said latex concentrate comprises from about 5 to about 70 wt. % of treated latex paint or comprises from about 1 to about 35 wt. % of treated latex paint, said latex concentrate comprising at least about 30 wt. %, at least about 40 wt. %, at least about 50 wt. %, at least about 60 wt. %, at least about 70 wt. %, at least about 80 wt. %, at least about 90 wt. %, at least about 95 wt. %, or at least about 99 wt. % of the one or more water-insoluble polymer component.

16. (canceled)

17. (canceled)

18. (canceled)

19. The polymeric film of claim 1, wherein:
(a) the polymeric film comprises no more than 1 wt. % of ethylene glycol, from about 0.1 to about 0.3 wt. % of ethylene glycol, or about 0.1 wt. % of ethylene glycol;
(b) volatile organic compounds (VOCs) and/or ethylene glycol have been substantially removed from the treated latex paint; and/or
(c) the treated latex paint has been treated chemically to esterify or oxidize ethylene glycol.

20. (canceled)

21. (canceled)

22. The polymeric film of claim 19, wherein the treated latex paint has been treated with a carboxylic acid, stearic acid, acetic acid, adipic acid, capric acid, lauric acid, myristic acid, palmitic acid, or propanoic acid to esterify ethylene glycol, and/or wherein the treated latex paint has been treated by heating to remove VOCs by subjecting the treated latex paint, under regular ambient pressure conditions, to a temperature of about 100° C. or higher, about 200° C. or higher, about 300° C. or higher, about 400° C. or higher, about 500° C. or higher, or to a temperature ranging from about 200° C. to about 500° C.; optionally wherein the treated latex paint has been further treated with an air neutralizer system after heating to destroy and/or remove VOCs.

23. (canceled)

24. (canceled)

25. (canceled)

26. (canceled)

27. (canceled)

28. The polymeric film of claim 1, wherein the treated latex paint has been treated by filtration, screening, and/or milling to remove and/or downsize particles or contaminants greater than about 25 microns to about 45 microns in size.

29. The polymeric film of claim 1, wherein the polymeric film is a monolayer film or a multilayer film comprising at least 3 layers, one or more layer in the multilayer film comprising about 0 wt. % to about 100 wt. % of latex concentrate.

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. A method for preparing treated latex paint for use in recycling waste latex paint in a polymeric film using a continuous film-making process, the method comprising the steps of:
a) reducing the initial moisture content of the latex paint to about 30 wt. % or less;
b) treating the latex paint to reduce, remove, or neutralize ethylene glycol and/or volatile organic compounds (VOCs); and
c) optionally, treating the latex paint to control particle-size distribution and/or top particle size of the latex paint;
optionally wherein the latex paint and/or the waste latex paint is non-reusable waste latex paint.

44. The method of claim 43, further comprising a step of liquid-solid separation and/or drying the latex paint to reduce moisture content to about 0.5 wt. % or less or to about 0.1 wt. % to about 0.5 wt. %, or to about 0.1 wt. %, or to about 15 wt. % or less, wherein the step of drying comprises heating at a temperature in the range of about 60° C. to about 600° C., about 100° C. to about 600° C., or about 200° C. to about 500° C. under regular ambient pressure conditions.

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. An article comprising the polymeric film according to claim 1, wherein the article is an area-measured plastic article, a plastic bag, an industrial liner, an agricultural film, a shrink film, or flexible packaging, the plastic bag optionally selected from a garbage bag, a merchandise bag, and a cement bag; wherein the article is about 0.5 to about 8 mils in thickness, or about 0.8 to about 4 mils in thickness; and/or wherein the article comprises no more than 1 wt. % of ethylene glycol; from about 0.1 to about 0.3 wt. % of ethylene glycol; about 0.1 wt. % of ethylene glycol; or no more than trace amounts of ethylene glycol.

89. (canceled)

90. (canceled)

91. (canceled)

92. (canceled)
